(19) United States
(12) Patent Application Publication
(10) Pub. No.: US 2017/0060012 A1
(43) Pub. Date: Mar. 2, 2017

(54) ELECTROSTATIC CHARGE IMAGE DEVELOPER, DEVELOPER CARTRIDGE, AND PROCESS CARTRIDGE

(71) Applicant: FUJI XEROX CO., LTD., Tokyo (JP)

(72) Inventor: Hiroshi KAMADA, Kanagawa (JP)

(73) Assignee: FUJI XEROX CO., LTD., Tokyo (JP)

(21) Appl. No.: 15/014,395

(22) Filed: Feb. 3, 2016

(30) Foreign Application Priority Data
Sep. 2, 2015 (JP) 2015-173329

(51) Int. Cl. G03G 9/087; G03G 9/107; G03G 9/08; G03G 21/18

(52) U.S. Cl. CPC G03G 9/08755; G03G 21/18; G03G 9/08711; G03G 9/1075; G03G 9/0819

(57) ABSTRACT

An electrostatic charge image developer includes an electrostatic charge image developing toner including toner particles and an external additive, and a carrier, wherein the toner particle contains a polyester resin and a styrene (meth)acrylic resin and includes domains of the styrene (meth)acrylic resin having an average diameter of 300 nm to 800 nm, and the carrier includes a magnetic particle dispersed core particle and a (meth)acrylic resin which contains a nitrogen atom on the surface of the core particle.

### CROSS-REFERENCE TO RELATED APPLICATIONS

This application is based on and claims priority under 35 USC 119 from Japanese Patent Application No. 2015-173329 filed Sep. 2, 2015.

### BACKGROUND

1. Technical Field

The present invention relates to an electrostatic charge image developer, a developer cartridge, and a process cartridge.

2. Related Art

A method of visualizing image information through electrophotography is currently used in various fields. In electrophotography, an electrostatic charge image is formed on a surface of an image holding member as image information through charging and electrostatic charge image formation. A toner image is formed on the surface of the image holding member using a developer containing a toner, and this toner image is transferred to a recording medium, and then the toner image is fixed onto a surface of the recording medium. The image information is visualized as an image through these processes.

### SUMMARY

According to an aspect of the invention, there is provided an electrostatic charge image developer including:

an electrostatic charge image developing toner including toner particles and an external additive; and

a carrier,

wherein the toner particle contains a polyester resin and a styrene (meth)acrylic resin and includes domains of the styrene (meth)acrylic resin having an average diameter of 300 nm to 800 nm, and

the carrier includes a magnetic particle dispersed core particle and a (meth)acrylic resin which contains a nitrogen atom on the surface of the core particle.

### BRIEF DESCRIPTION OF THE DRAWINGS

Exemplary embodiments of the present invention will be described in detail based on the following figures, wherein:

FIG. 1 is a configuration diagram showing an example of an image forming apparatus according to the exemplary embodiment; and

FIG. 2 is a configuration diagram showing an example of a process cartridge according to the exemplary embodiment.

### DETAILED DESCRIPTION

Hereinafter, exemplary embodiments which are examples of the invention will be described in detail.

Electrostatic Charge Image Developer

An electrostatic charge image developer (hereinafter, also referred to as a “developer”) according to the exemplary embodiment contains an electrostatic charge image developing toner (hereinafter, also referred to as a “toner”) and a carrier.

The toner includes a toner particle which includes a binder resin containing a polyester resin and a styrene (meth)acrylic resin, in which domains of the styrene (meth)acrylic resin having an average diameter of 300 nm to 800 nm are formed.

The carrier includes a magnetic particle dispersed core particle and a coating layer which is provided on the surface of the core particle and contains a resin having a structural unit derived from a (meth)acrylic acid derivative containing a nitrogen atom. The resin having a structural unit derived from a (meth)acrylic acid derivative containing a nitrogen atom indicates a resin obtained by at least polymerizing a (meth)acrylic acid derivative containing a nitrogen atom.

With the developer according to the exemplary embodiment, a decrease in image density occurring when repeatedly forming an image on both surfaces of a recording medium is prevented in a direct transfer-type and toner reclaiming-type image forming apparatus, due to a combination of the toner and the carrier. The reason therefor is not clear, but the following are assumed.

In an electrophotographic image forming apparatus, a developer containing a toner and a magnetic carrier is used, from viewpoints of image quality, durability, and high-speed correspondence. In recent years, a toner having low temperature fixability is effective as the toner contained in the developer, from requirements in the market with respect to realization of high speed and energy saving of an image forming apparatus.

However, a toner containing a polyester resin as a binder resin is excellent, for example, because the toner has low temperature fixability. When an image is formed using a toner containing a polyester resin, an external additive may be embedded in a toner particle due to mechanical loads, thermal loads, and the like. When an external additive is embedded in a toner particle, fluidity of the toner is decreased and a charging amount is easily decreased.

Meanwhile, when a charging amount of the toner is decreased, the image forming apparatus is controlled so that the toner concentration is decreased in a developing unit (developing device), in order to maintain the charging amount of the toner necessary for the development. When the charging amount of the toner is decreased at the time of forming an image by an image forming apparatus which is controlled as described above, the image forming apparatus decreases the toner concentration in the developing unit by the controlling described above, in order to maintain the charging amount of the toner. Since the toner concentration in the developing unit is decreased, an amount of toner supplied for the development of a toner image may be decreased and image density may be decreased.

It is found that the phenomenon, in which the image density is decreased, is remarkably easy to occur, when images are repeatedly formed on both surfaces of a recording medium (for example, continuous printing of 100,000 sheets) using the toner containing the polyester resin as a binder resin, particularly by a direct transfer-type image forming apparatus which employs a system (so-called toner reclaiming type) of removing toner remaining on a surface of an image holding member (photoreceptor) by a cleaning unit and supplies the removed toner to a developing unit to reuse the toner.

The phenomenon, in which image density is decreased when images are repeatedly formed on both surfaces of a recording medium using the toner containing the polyester resin as a binder resin, in the image forming apparatus (direct transfer-type and toner reclaiming-type image forming apparatus) will be described as follows.

When images are repeatedly formed on both surfaces of a recording medium by the image forming apparatus, first, the recording medium is warmed by heat received from a fixing unit and maintains the heat, when fixing a toner image transferred to one surface of the recording medium. Then, when transferring the toner image to the other surface, an image holding member is warmed by heat maintained by the recording medium. When the image holding member is warmed, the heat is transferred to toner remaining on a surface of the image holding member and the toner receives thermal loads. The toner which receives thermal loads is supplied to a developing unit through a supply feeding path of a toner reclaiming type developing device. In the toner which receives thermal loads, an external additive is easily embedded in a toner particle.

In addition, the toner containing the polyester resin receives mechanical loads by stirring performed in the developing unit, and accordingly, an external additive is easily embedded in a toner particle.

As a result, fluidity of the toner present in the developing unit easily decreases and a charging amount thereof easily decreases due to the toner in which an external additive is embedded in a toner particle.

Meanwhile, the carrier in the developing unit also receives mechanical loads due to stirring performed in the developing unit, and a charging imparting ability to the toner decreases due to the mechanical loads. The carrier having a decreased charging imparting ability to the toner has a small effect of charging a toner, and accordingly, a charging amount of the toner easily decreases.

Since the toner which is present in the developing unit of the image forming apparatus and contains a toner particle in which an external additive is embedded has a low charging amount, the image forming apparatus having the above-mentioned setting decreases the toner concentration in the developing unit, in order to maintain a charging amount of the toner necessary for the development. Asa result, an amount of toner supplied for the development of a toner image is decreased and image density is easily decreased.

With respect to this, the developer according to the exemplary embodiment includes, in a combined manner, a toner which includes a toner particle containing a binder resin containing a polyester resin, and a styrene (meth)acrylic resin, in which domains of the styrene(meth)acrylic resin having an average diameter of 300 nm to 800 nm are formed, and a carrier which includes a magnetic particle dispersed core particle and a coating layer which is provided on the surface of the core particle and contains a resin having a structural unit derived from a (meth)acrylic acid derivative containing a nitrogen atom.

Since the toner includes the toner particle containing the styrene (meth)acrylic resin which forms domains having an average diameter of 300 nm to 800 nm, resistance to thermal loads and mechanical loads applied to the toner is improved and the embedding of an external additive in a toner particle is easily prevented. As a result, a decrease in a charging amount of the toner is prevented.

Since the core particle is a magnetic particle dispersion type, the carrier has a smaller specific gravity than that of a magnetic particle (for example, ferrite particle). Accordingly, mechanical loads applied to the carrier in the developing unit are easily decreased and a decrease in a charging imparting ability to the toner is prevented. Since the coating layer contains a resin having a structural unit derived from a (meth)acrylic acid derivative containing a nitrogen atom, it is easy to ensure a charging imparting ability to the toner. A (meth)acrylic acid derivative containing a nitrogen atom maintains a high charging imparting ability to the toner, even when a temperature is increased.

As a result, in a carrier in which the core particle and the coating layer are combined with each other, a charging imparting ability to the toner is easily stabilized.

As described above, in the developer according to the exemplary embodiment, a decrease in a charging amount of the toner is prevented and a charging imparting ability of the carrier to the toner is easily maintained by the configuration in which the toner and the carrier are combined with each other. As a result, with the developer according to the exemplary embodiment, a decrease in image density occurring when repeatedly forming an image on both surfaces of a recording medium is prevented in a direct transfer-type and toner reclaiming-type image forming apparatus.

As described above, it is assumed that a decrease in image density is prevented with the developer according to the exemplary embodiment by the configuration described above.

As described above, a decrease in a charging amount of the toner is prevented with the developer according to the exemplary embodiment by the configuration in which the toner and the carrier are combined with each other. Therefore, in a direct transfer-type and toner reclaiming-type image forming apparatus, formation of image defects such as fogging or black spots is easily prevented, even when images are repeatedly formed on both surfaces of a recording medium.

Hereinafter, the toner and the carrier configuring the developer according to the exemplary embodiment will be described in detail.

Electrostatic Charge Image Developing Toner

An electrostatic charge image developing toner (hereinafter, referred to as a “toner”) according to the exemplary embodiment contains a toner particle and an external additive.

Toner Particle

The toner particle, for example, contains a binder resin containing a polyester resin, a styrene (meth)acrylic resin, and if necessary, a release agent, a colorant, and other additives.

Binder Resin

As the binder resin, the polyester resin is used from a viewpoint of the fixability. An amount of the polyester resin with respect to the entire binder resin is, for example, preferably equal to or greater than 85% by weight, more preferably equal to or greater than 95% by weight, and even more preferably 100% by weight.

As the polyester resin, a well-known polyester resin is used, for example.

Examples of the polyester resin include condensation polymers of polyvalent carboxylic acids and polyols. A commercially available product or a synthesized product may be used as the polyester resin.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adduct of bisphenol A and propylene oxide adduct of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with a diol. Examples of the tri- or higher-valent polyol include glycerin, trimethylolpropane, and pentaerythritol.

The polyols may be used alone or in combination of two or more kinds thereof.

The glass transition temperature (Tg) of the polyester resin is preferably from 50° C. to 80° C., and more preferably from 50° C. to 65° C.

The glass transition temperature is obtained by a DSC curve which is obtained by a differential scanning calorimetry (DSC), and more specifically, is obtained by “Extrapolating Glass Transition Starting Temperature” disclosed in a method for obtaining the glass transition temperature of “Testing Methods for Transition Temperatures of Plastics” in JIS K-7121-1987.

A weight-average molecular weight (Mw) of the polyester resin is preferably from 5,000 to 1,000,000, and more preferably from 7,000 to 500,000.

The number-average molecular weight (Mn) of the polyester resin is preferably from 2,000 to 100,000.

The molecular weight distribution Mw/Mn of the polyester resin is preferably from 1.5 to 100, and more preferably from 2 to 60.

The weight-average molecular weight and the number-average molecular weight are measured by gel permeation chromatography (GPC). The molecular weight measurement by GPC is performed with a THF solvent using HLC-8120 GPC, which is GPC manufactured by Tosoh Corporation as a measurement device by using TSKGEL Super HM-M (15 cm), which is a column manufactured by Tosoh Corporation. The weight-average molecular weight and the number-average molecular weight are calculated using a calibration curve of molecular weight created with a monodisperse polystyrene standard sample from results of this measurement.

The polyester resin is obtained with a well-known preparing method. Specific examples thereof include a method of conducting a reaction at a polymerization temperature set to 180° C. to 230° C., if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with the major component.

The content of the binder resin is preferably from 40% by weight to 95% by weight, more preferably from 50% by weight to 90% by weight, and even more preferably from 60% by weight to 85% by weight, with respect to the entire toner particles.

In addition, as the binder resin, other binder resins may be used in combination with the polyester resin.

Examples of the other binder resins include a homopolymer of a monomer such as styrenes (for example, styrene, p-chlorostyrene, α-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenic unsaturated nitriles (for example, acrylonitrile, methacrylonitrile, or the like), vinyl esters (for example, vinyl methyl ether, vinyl isobutyl ether, or the like), vinyl ketones (for example, vinyl methyl ketone, vinyl ethyl ketone, vinyl isopropenyl ketone, or the like), and olefins (for example, ethylene, propylene, butadiene, or the like), or a vinyl resin formed of a copolymer obtained by combining two or more kinds of the monomers (herein, except for the styrene (meth)acrylic resin).

Examples of the other binder resins include a non-vinyl resin such as an epoxy resin, a polyester resin, a polyurethane resin, a polyamide resin, a cellulose resin, a polyether resin, and modified rosin, a mixture of these and the vinyl resin, or a graft polymer obtained by polymerizing the vinyl monomer under coexistence thereof.

The other binder resins may be used alone or in combination with two or more kinds thereof.

### Styrene (Meth)Acrylic Resin

The styrene (meth)acrylic resin is a copolymer prepared by copolymerizing at least a monomer having a styrene skelton and a monomer having a (meth)acryloyl skelton.

Incidentally, the term “(meth)acryl” as used herein means acryl or methacryl, and the term “(meth)acryloyl” as used herein means acryloyl or methacryloyl.

Examples of the monomer including a styrene skeleton (hereinafter, referred to as a “styrenic monomer”) include styrene, alkyl-substituted styrene (for example, α-methyl styrene, 2-methylstyrene, 3-methylstyrene, 4-methylstyrene, 2-ethylstyrene, 3-ethylstyrene, 4-ethylstyrene, and the like), halogen-substituted styrene (for example, 2-chlorostyrene, 3-chlorostyrene, 4-chlorostyrene, and the like), vinyl naphthalene, and the like. The styrenic monomer may be used alone or in combination of two or more kinds thereof.

Among these, as the styrenic monomer, styrene is preferable from viewpoints of favorable reactivity, easy control of the reaction, and availability.

Examples of the monomer including a (meth)acrylic skeleton (hereinafter, referred to as a “(meth)acrylic monomer”) include (meth)acrylic acid, (meth)acrylic acid ester, and the like. Examples of the (meth)acrylic acid ester include alkyl (meth)acrylate (for example, methyl (meth)acrylate, ethyl (meth)acrylate, n-propyl (meth)acrylate, n-butyl (meth)acrylate, n-pentyl (meth)acrylate, n-hexyl acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, t-butylcyclohexyl (meth)acrylate, and the like), aryl ester (meth)acrylate (for example, phenyl (meth)acrylate, biphenyl (meth)acrylate, diphenylethyl (meth)acrylate, t-butylphenyl (meth)acrylate, terphenyl (meth)acrylate, and the like), dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylamide, and the like. The (meth)acrylic monomer may be used alone or in combination of two or more kinds thereof.

Herein, a weight ratio of the styrenic monomer and the (meth)acrylic monomer (styrenic monomer/(meth)acrylic monomer)) is, for example, preferably from 85/15 to 70/30.

The styrene (meth)acrylic resin may include a crosslinked structure, in order to further prevent a decrease in image density. For example, as the styrene (meth)acrylic resin including a crosslinked structure, a cross linked product obtained by copolymerizing and cross linking at least a styrene monomer, a (meth)acrylic acid monomer, and a cross-linkable monomer is used.

Examples of the cross-linkable monomer include a bi- or higher functional cross-linking agent.

Examples of the bifunctional cross-linking agent include divinyl benzene, divinyl naphthalene, a di(meth)acrylate compound (for example, diethylene glycol di(meth)acrylate, methylenebis (meth)acrylamide, decane diol diacrylate, glycidyl (meth)acrylate, and the like), polyester type di(meth)acrylate, 2-([1′-methylpropylidene amino] carboxy amino) ethyl methacrylate, and the like.

Examples of the multifunctional cross-linking agent include a tri(meth)acrylate compound (for example, pentaerythritol tri(meth)acrylate, trimethylolethane tri(meth)acrylate, trimethylolpropane tri(meth)acrylate, and the like), a tetra(meth)acrylate compound (for example, tetramethylolmethane tetra(meth)acrylate, oligoester (meth)acrylate, and the like), 2,2-bis (4-methacryloxy, polyethoxyphenyl) propane, diallyl phthalate, triallyl cyanurate, triallyl isocyanurate, triallyl trimellitate, diaryl chlorendate, and the like.

A copolymerization ratio of the cross-linkable monomer with respect to the entire monomers (cross-linkable monomer/entire monomers based on weight) may be, for example, from 2/1,000 to 30/1,000.

A weight average molecular weight of the styrene (meth)acrylic resin may be, for example, from 30,000 to 200,000, is preferably from 40,000 to 100,000, and more preferably from 50,000 to 80,000, from a viewpoint of storage stability.

The weight average molecular weight of the styrene (meth)acrylic resin is a value measured in the same method as the weight average molecular weight of the polyester resin.

A glass transition temperature (Tg) of the styrene (meth)acrylic resin may be, for example, from 50° C. to 75° C., is preferably from 55° C. to 65° C., and more preferably from 57° C. to 60° C., in order to further prevent a decrease in image density.

The glass transition temperature (Tg) of the styrene (meth)acrylic resin is determined by a DSC curve obtained by differential scanning calorimetry (DSC), and more specifically, is determined by “extrapolation glass transition starting temperature” disclosed in a method of determining the glass transition temperature of JIS K7121-1987 “Testing Methods for Transition Temperature of Plastics”.

The content of the styrene (meth)acrylic resin may be, for example, from 10% by weight to 30% by weight, is preferably from 12% by weight to 28% by weight, and more preferably from 15% by weight to 25% by weight with respect to the toner particles, in order to further prevent a decrease in image density.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

Among these, hydrocarbon waxes (waxes including hydrocarbon as a skeleton) are preferable as the release agent. The hydrocarbon waxes are suitable, because the waxes rapidly bleed to the surface of the toner (toner particle) at the time of fixing and peeling properties are obtained.

Examples of hydrocarbon waxes include synthetic waxes such as Fischer Tropsch Wax, polyethylene wax (wax including a polyethylene skeleton), and polypropylene wax (wax including a polypropylene skeleton); and petroleum wax such as paraffin wax (wax including a paraffin skeleton), and microcrystalline wax. Among the hydrocarbon waxes, the synthetic waxes are preferable in a viewpoint of peeling properties. Particularly, Fischer Tropsch Wax is more preferable in order to further prevent a decrease in image density.

When using the hydrocarbon waxes, the content of the hydrocarbon waxes with respect to the entire release agent may be from 85% by weight to 100% by weight and is preferably from 95% by weight to 100% by weight. The content thereof is more preferably 100% by weight.

A melting temperature of the release agent is, for example, preferably from 50° C. to 110° C. and more preferably from 60° C. to 100° C.

The melting temperature is determined from a DSC curve obtained by differential scanning calorimetry (DSC), using the “melting peak temperature” described in the method of determining a melting temperature in the “Testing Methods for Transition Temperatures of Plastics” in JIS K-7121-1987.

The content of the release agent is, for example, preferably from 1% by weight to 20% by weight and more preferably from 5% by weight to 15% by weight, with respect to the entirety of the toner particles.

Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, Rhodamine B Lake, Lake Red C, pigment red, rose bengal, aniline blue, ultramarine blue, calco oil blue, methylene blue chloride, phthalocyanine blue, pigment blue, phthalocyanine green, and malachite green oxalate, and various dyes such as acridine dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, aniline black dyes, polymethine dyes, triphenylmethane dyes, diphenylmethane dyes, and thiazole dyes.

The colorants may be used alone or in combination of two or more kinds thereof.

If necessary, the colorant may be surface-treated or used in combination with a dispersing agent. Plural kinds of colorants may be used in combination.

The content of the colorant is, for example, preferably from 1% by weight to 30% by weight, and more preferably from 3% by weight to 15% by weight with respect to the entirety of the toner particles.

Other Additives

Examples of other additives include known additives such as a magnetic material, a charge-controlling agent, and an inorganic powder. The toner particles contain these additives as internal additives.

Characteristics of Toner Particles

The toner particles may be toner particles having a single-layer structure, or toner particles having a so-called core/shell structure composed of a core (core particle) and a coating layer (shell layer) coated on the core, but the toner particles having a core/shell structure are preferable.

Here, toner particles having a core/shell structure are preferably composed of, for example, a core containing a binder resin and, if necessary, other additives such as a colorant and a coating layer containing a binder resin and a release agent.

The volume average particle size (D50v) of the toner particles is preferably from 2 μm to 10 μm, and more preferably from 4 μm to 8 μm.

Various average particle sizes and various particle size distribution indices of the toner particles are measured using a COULTER MULTISIZSER II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% aqueous solution of surfactant (preferably sodium alkylbenzene sulfonate) as a dispersing agent. The obtained material is added to 100 ml to 150 ml of the electrolyte.

The electrolyte in which the sample is suspended is subjected to a dispersion treatment using an ultrasonic disperser for 1 minute, and a particle size distribution of particles having a particle size of 2 μm to 60 μm is measured by a COULTER MULTISIZER II using an aperture having an aperture size of 100 μm. 50,000 particles are sampled.

Cumulative distributions by volume and by number are drawn from the side of the smallest size with respect to particle size ranges (channels) separated based on the measured particle size distribution. The particle size when the cumulative percentage becomes 16% is defined as that corresponding to a volume average particle size D16v and a number-average particle size D16p, while the particle size when the cumulative percentage becomes 50% is defined as that corresponding to a volume average particle size D50v and a number-average particle size D50p. Furthermore, the particle size when the cumulative percentage becomes 84% is defined as that corresponding to a volume average particle size D84v and a number-average particle size D84p.

Using these, a volume average particle size distribution index (GSDv) is calculated as (D84v/D16v)^{1/2}, while a number-average particle size distribution index (GSDp) is calculated as (D84p/D16p)^{1/2}.

The shape factor SF1 of the toner particles is preferably from 110 to 150, and more preferably from 120 to 140.

The shape factor SF1 is obtained through the following expression.

Expression: SF1=(ML²/A)×(π/4)×100

In the foregoing expression, ML represents an absolute maximum length of a toner, and A represents a projected area of a toner.

Specifically, the shape factor SF1 is numerically converted mainly by analyzing a microscopic image or a scanning electron microscopic (SEM) image by using of an image analyzer, and is calculated as follows. That is, an optical microscopic image of particles scattered on a surface of a glass slide is input to an image analyzer LUZEX through a video camera to obtain maximum lengths and projected areas of 100 particles, values of SF1 are calculated through the foregoing expression, and an average value thereof is obtained.

In the toner particle of the toner configuring the developer according to the exemplary embodiment, an average diameter of the domains of the styrene (meth)acrylic resin is from 300 nm to 800 nm. When the average diameter thereof is in the range described above, the embedding of an external additive in a toner particle is easily prevented and a decrease in image density is prevented. The average diameter thereof is preferably from 350 nm to 750 nm and more preferably from 400 nm to 700 nm, in order to further prevent a decrease in image density.

In the domains of the styrene (meth)acrylic resin, a percentage of the number of domains having a diameter which is in a range of ±0.1 μM from the average diameter is preferably equal to or greater than 65%. The percentage of the number thereof is preferably equal to or greater than 70% and more preferably equal to or greater than 75%, in order to further prevent a decrease in image density.

Hereinafter, a method of measuring the average diameter of the domains of the styrene (meth)acrylic resin will be described.

A sample and an image for measurement are prepared by the following method.

A toner is mixed with and embedded in an epoxy resin and the epoxy resin is cured. This cured substance is cut with an ultra-microtome device (for example, ULTRACUT UCT manufactured by Leica Microsystems) to thereby obtain a thin sample having a thickness of 80 nm to 130 nm. Next, the obtained thin sample is dyed in a desiccator at 30° C. for 3 hours with ruthenium tetroxide. A SEM image of the dyed thin sample is obtained with an ultrahigh-resolution field emission scanning type electron microscope (FE-SEM: S-4800 manufactured by Hitachi High-Technologies Corporation.). Since the release agent, the styrene (meth)acrylic resin and the polyester resin are easily dyed with ruthenium tetroxide in this order, each component is identified with gradation caused by a dyed extent. When it is difficult to differentiate the gradation due to the state of the sample, the dying time is adjusted.

In a cross section of the toner particle, the size of the domains of the colorant is smaller than that of the domains of the release agent and the domains of the styrene (meth)acrylic resin, and accordingly, these are distinguished by the size.

The average diameter of the domains of the styrene (meth)acrylic resin is a value measured by the following method.

In the SEM image, 30 toner particle cross sections in which the maximum length is equal to or greater than 85% of a volume average particle diameter of the toner particles are selected and total 100 domains of the dyed styrene (meth)acrylic resin are observed. Each maximum length of the domains is measured, the maximum length is assumed as a diameter of the domain, and a calculated average thereof is set as an average diameter.

The percentage of the number of domains having a diameter which is in a range of ±100 nm of the average diameter is determined based on each measured diameter of total 100 domains.

The average diameter of the domains of the styrene (meth)acrylic resin and the distribution of the domain size are controlled by methods of preparing toner particles by aggregation and coalescence and adjusting a volume average particle diameter of resin particles contained in a styrene (meth)acrylic resin particle dispersion used at the time of preparation; preparing plural styrene (meth)acrylic resin particle dispersions having different volume average particle diameters and using these in combination; and the like.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

Surfaces of the inorganic particles as an external additive are preferably subjected to a hydrophobizing treatment. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

Examples of the external additive also include resin particles (resin particles such as polystyrene, PMMA, and melamine resin particles) and a cleaning aid (e.g., metal salt of higher fatty acid represented by zinc stearate, and fluorine-based polymer particles).

The amount of the external additive externally added is, for example, preferably from 0.01% by weight to 5% by weight, and more preferably from 0.01% by weight to 2.0% by weight with respect to the toner particles.

As the external additive, among the external additives described above, inorganic particles having a volume average particle diameter of 80 nm to 200 nm may be contained, in order to further prevent a decrease in image density. The volume average particle diameter is preferably from 100 nm to 200 nm and more preferably from 120 nm to 180 nm.

The inorganic particles having a volume average particle diameter of 80 nm to 200 nm may be used alone or in combination of two or more kinds.

The volume average particle diameter of the external additive is measured by the following method.

500 primary particles of the inorganic particles attached to the toner particles of the toner which is a measurement target are observed using a scanning electron microscope (SEM) with magnification of 40,000, the maximum diameter and the minimum diameter for each particle are measured by the image analysis of the primary particles, and an equivalent spherical diameter is measured from a median value thereof. A diameter with the cumulative percentage of 50% of the obtained equivalent spherical diameter (D50v) is set as the average particle diameter (that is, volume average particle diameter) of the external additive.

The content of inorganic particles having a volume average particle diameter of 80 nm to 200 nm is preferably from 0.01% by weight to 5% by weight and more preferably from 0.01% by weight to 2.0% by weight with respect to the toner particles.

The inorganic particles having a volume average particle diameter of 80 nm to 200 nm is not particularly limited, and may be used alone or in combination of two or more kinds thereof. For example, as the inorganic particles, at least one kind selected from a group consisting of silica particles, titania particles, and alumina particles may be contained.

Specific examples of silica particles include sol-gel silica particles, aqueous colloidal silica particles, alcoholic silica particles, fumed silica particles obtained by a gas phase method, and fused silica particles.

Specific examples of titania particles include anatase-type titania and rutile-type titania particles.

Specific examples of alumina particles include alumina anhydride such as α-alumina, δ-alumina, θ-alumina, and χ-alumina, and active calcium oxide.

Among these, it is preferable that at least one kind of the silica particles and the titania particles is contained. The sol-gel silica particles are preferable among the silica particles, and metatitanic acid particles are preferable among the titania particles. As the inorganic particles having a volume average particle diameter of 80 nm to 200 nm, for example, sol-gel silica particles and the metatitanic acid particles may be used in combination.

The sol-gel silica particles may be prepared by a method of obtaining silica sol with water glass as a raw material or may be prepared by a method (so-called wet method) of forming particles by a sol-gel method with a silicon compound represented by alkoxysilane as a raw material. The sol-gel silica particles are obtained, for example, by a method of preparing an alkali catalyst solution containing an alkali catalyst in a solvent containing alcohol and supplying tetraalkoxysilane into the alkali catalyst solution, and supplying the alkali catalyst.

Metatitanic acid indicates a material in which n=1 in titanium acid hydrate TiO₂.nH₂O.

The metatitanic acid particles are normally refined by a wet method of allowing chemical reaction in a solvent. The wet method is divided into a sulfuric acid method and a hydrochloric acid method. The following reaction proceeds in a liquid phase and TiO(OH)₂ is obtained by hydrolysis by the sulfuric acid method.

FeTiO₃+2H2SO₄→FeSO₄+TiOSO₄+2H₂O

TiOSO₄+2H₂O→TiO(OH)₂+H₂SO₄

In the hydrochloric acid wet method, first, titanium tetrachloride is formed by chlorination by the same method as in the dry method, dissolved in water, and subjected to hydrolysis while putting a strong base thereto, and TiO(OH)₂ is obtained. This is shown as follows as a reaction formula.

TiCl₄+H₂O→TiOCl₂+2HCl

TiOCl₂+2H₂O→TiO(OH)₂+2HCl

Toner Preparing Method

Next, a method of preparing a toner according to this exemplary embodiment will be described.

The toner according to this exemplary embodiment is obtained by externally adding an external additive to toner particles after preparing of the toner particles.

The toner particles may be prepared using any of a dry preparing method (e.g., kneading and pulverizing method) and a wet preparing method (e.g., aggregation and coalescence method, suspension and polymerization method, and dissolution and suspension method). The toner particle preparing method is not particularly limited to these preparing methods, and a known preparing method is employed.

Among these, the toner particles are preferably obtained by an aggregation and coalescence method.

Specifically, for example, when the toner particles are manufactured by an aggregation and coalescence method, the toner particles are manufactured through the processes of: preparing a polyester resin particle dispersion in which polyester resin particles are dispersed (polyester resin particle dispersion preparation process); preparing a styrene (meth)acrylic resin particle dispersion in which styrene (meth)acrylic resin particles are dispersed (styrene (meth)acrylic resin particle dispersion preparation process); aggregating resin particles (and other particles, if necessary) in a mixed dispersion obtained by mixing the two resin particle dispersions (a dispersion obtained by also mixing other particle dispersions of a release agent and a colorant, if necessary), to form aggregated particles; and heating an aggregated particle dispersion in which the aggregated particles are dispersed, to coalesce the aggregated particles, thereby forming toner particles (coalescence process).

Hereinafter, the respective processes will be described in detail.

In the following description, a method of obtaining toner particles containing a colorant and a release agent will be described, but the colorant and the release agent are used if necessary. Additives other than the colorant may be used.

Resin Particle Dispersion Preparation Process

First, for example, a styrene (meth)acrylic resin particle dispersion in which styrene (meth)acrylic resin particles are dispersed, a colorant dispersion in which colorant particles are dispersed, and a release agent particle dispersion in which release agent particles are dispersed are prepared together with a resin particle dispersion in which polyester resin particles as a binder resin are dispersed.

The polyester resin particle dispersion is prepared by, for example, dispersing polyester resin particles by a surfactant in a dispersion medium.

Examples of the dispersion medium used for the polyester resin particle dispersion include aqueous mediums.

Examples of the aqueous mediums include water such as distilled water and ion exchange water; and alcohols. These may be used alone or in combination of two or more kinds thereof.

Examples of the surfactant include anionic surfactants such as sulfuric ester salt, sulfonate, phosphate, and soap anionic surfactants; cationic surfactants such as amine salt and quaternary ammonium salt cationic surfactants; and nonionic surfactants such as polyethylene glycol, alkyl phenol ethylene oxide adduct, and polyol nonionic surfactants. Among these, anionic surfactants and cationic surfactants are particularly used. Nonionic surfactants may be used in combination with anionic surfactants or cationic surfactants.

The surfactants may be used alone or in combination of two or more kinds thereof.

As a method of dispersing the polyester resin particles in the dispersion medium, a common dispersing method using, for example, a rotary shearing-type homogenizer, or a ball mill, a sand mill, or a DYNO mill having media is exemplified. In addition, the polyester resin particles may be dispersed in a dispersion medium by a phase inversion emulsification method. The phase inversion emulsification method includes: dissolving a resin to be dispersed in a hydrophobic organic solvent in which the resin is soluble; conducting neutralization by adding a base to an organic continuous phase (O phase); performing phase inversion from W/O to O/W by putting water (W phase), thereby dispersing the resin as particles in the aqueous medium.

A volume average particle diameter of the polyester resin particles dispersed in the polyester resin particle dispersion is, for example, preferably from 0.01 μm to 1 μm, more preferably from 0.08 μm to 0.8 μm, and even more preferably from 0.1 μm to 0.6 μm.

Regarding the volume average particle diameter of the polyester resin particles, a cumulative distribution by volume is drawn from the side of the smallest diameter with respect to particle size ranges (channels) separated using the particle size distribution obtained by the measurement of a laser diffraction-type particle size distribution measuring device (for example, manufactured by Horiba, Ltd., LA-700), and a particle diameter when the cumulative percentage becomes 50% with respect to the entire particles is measured as a volume average particle diameter D50v. The volume average particle diameter of the particles in other dispersions is also measured in the same manner.

The content of the polyester resin particles contained in the polyester resin particle dispersion is, for example, preferably from 5% by weight to 50% by weight, and more preferably from 10% by weight to 40% by weight.

The styrene (meth)acrylic resin particle dispersion, the colorant particle dispersion, and the release agent particle dispersion are also prepared in the same manner as in the case of the polyester resin particle dispersion. That is, the particles in the polyester resin particle dispersion are the same as the styrene (meth)acrylic resin particles dispersed in the styrene (meth)acrylic resin particle dispersion, the colorant particles dispersed in the colorant particle dispersion, and the release agent particles dispersed in the release agent particle dispersion, in terms of the volume average particle diameter, the dispersion medium, the dispersing method, and the content of the particles.

Aggregated Particle Forming Process

Next, the polyester resin particle dispersion, the styrene (meth)acrylic resin particle dispersion, the release agent particle dispersion, and the colorant particle dispersion are mixed together with each other.

The polyester resin particles, the styrene (meth)acrylic resin particles, the colorant particles, and the release agent particles are heterogeneously aggregated in the mixed dispersion, thereby forming aggregated particles having a diameter near a target toner particle diameter and including the polyester resin particles, the styrene (meth)acrylic resin particles, the colorant particles, and the release agent particles.

Specifically, for example, an aggregating agent is added to the mixed dispersion and a pH of the mixed dispersion is adjusted to acidic (for example, the pH is from 2 to 5). If necessary, a dispersion stabilizer is added. Then, the mixed dispersion is heated at a temperature of the glass transition temperature of the polyester resin (specifically, for example, from a temperature 30° C. lower than the glass transition temperature of the polyester resin to a temperature 10° C. lower than the glass transition temperature) to aggregate the particles dispersed in the mixed dispersion, thereby forming the aggregated particles.

In the aggregated particle forming process, for example, the aggregating agent may be added at room temperature (for example, 25° C.) under stirring of the mixed dispersion using a rotary shearing-type homogenizer, the pH of the mixed dispersion may be adjusted to acidic (for example, the pH is from 2 to 5), a dispersion stabilizer may be added if necessary, and the heating may then be performed.

Examples of the aggregating agent include a surfactant having an opposite polarity to the polarity of the surfactant used as the dispersing agent to be added to the mixed dispersion, such as inorganic metal salts and di- or higher-valent metal complexes. Particularly, when a metal complex is used as the aggregating agent, the amount of the surfactant used is reduced and charging characteristics are improved.

If necessary, an additive may be used to form a complex or a similar bond with the metal ions of the aggregating agent. A chelating agent is preferably used as the additive.

Examples of the inorganic metal salt include a metal salt such as calcium chloride, calcium nitrate, barium chloride, magnesium chloride, zinc chloride, aluminum chloride, and aluminum sulfate, and inorganic metal salt polymer such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid; aminocarboxylic acid such as iminodiacetic acid (IDA), nitrilotriacetic acid (NTA), and ethylenediaminetetraacetic acid (EDTA).

An addition amount of the chelating agent is, for example, preferably in a range of from 0.01 parts by weight to 5.0 parts by weight, and more preferably in a range of from 0.1 parts by weight to less than 3.0 parts by weight relative to 100 parts by weight of the resin particles.

Coalescence Process

Next, the aggregated particle dispersion in which the aggregated particles are dispersed is heated at, for example, a temperature that is equal to or higher than the glass transition temperature of the polyester resin particles (for example, a temperature that is higher than the glass transition temperature of the polyester resin by 10° C. to 50° C.) to coalesce the aggregated particles and form toner particles.

The toner particles are obtained through the above-described processes.

After the aggregated particle dispersion in which the aggregated particles are dispersed is obtained, toner particles may be prepared through the processes of: further mixing the aggregated particle dispersion with a resin particle dispersion in which resin particles are dispersed to perform aggregation so that the resin particles further adhere to the surfaces of the aggregated particles, thereby forming second aggregated particles; and coalescing the second aggregated particles by heating the second aggregated particle dispersion in which the second aggregated particles are dispersed, and thereby forming toner particles having a core/shell structure.

After the coalescence process is ended, toner particles formed in a solution are subjected to a well-known washing process, a well-known solid-liquid separation process, a well-known drying process, and thereby dried toner particles are obtained.

Regarding the washing process, replacing washing using ion exchanged water may preferably be sufficiently performed for charging property. The solid-liquid separation process is not particularly limited, but suction filtration, pressure filtration, or the like may preferably be performed for productivity. The drying process is not particularly limited, but freeze drying, flash jet drying, fluidized drying, vibrating fluidized drying, and the like may preferably be performed for productivity.

The toner according to the exemplary embodiment is prepared, for example, by adding an external additive to the obtained toner particles in a dried state, and performing mixing. The mixing may be performed, for example, by using a V blender, a HENSCHEL mixer, a LODIGE mixer, or the like. Furthermore, if necessary, coarse toner particles may be removed using a vibration sieving machine, a wind classifier, or the like.

Carrier

The carrier of the exemplary embodiment includes a magnetic particle dispersed core particle in which a magnetic particle is dispersed and blended in a matrix resin, and a coating layer which is provided on the surface of the core particle and contains a resin having a structural unit derived from a (meth)acrylic acid derivative containing a nitrogen atom.

Core Particle

The magnetic particle used for the magnetic particle dispersed core particle is not particularly limited, and any well-known magnetic particle of the related art may be used. Specifically, γ-iron oxide, ferrite, or magnetite may be used, and ferrite and magnetite may be used in order to obtain excellent stability, and magnetite is preferable, from a viewpoint of low cost.

Examples of ferrite include particles of ferrite represented by the following structural formula.

Structural formula: (MO)ₓ(Fe₂O₃)_{Y}

(in the structural formula, M represents at least one kind of metal element selected from Cu, Zn, Fe, Mg, Mn, Ca, Li, Ti, Ni, Sn, Sr, Al, Ba, Co, and Mo. X and Y represent a molar ratio and satisfy a relationship of X+Y=100)

As ferrite having a structure having plural metal elements as M among the structure represented by the structural formula, for example, iron oxide such as a Mn—Zn ferrite, a Ni—Zn ferrite, a Mn—Mg ferrite, a Li ferrite, and a Cu—Zn ferrite is used.

The volume average particle diameter of the magnetic particle may be in a range of 0.01 μm to 1 μm, is preferably in a range of 0.03 μm to 0.5 μm and more preferably in a range of 0.05 μm to 0.35 μm.

The volume average particle diameter of the magnetic particle is a value measured using a laser diffraction-scattering type particle size distribution measuring device (LS Particle size analyzer: LS13 320 manufactured by Beckman Coulter, Inc.) Cumulative distributions by volume are drawn from the side of the smallest diameter with respect to particle size ranges (channels) separated based on the particle size distribution obtained and the particle diameter when the cumulative percentage becomes 50% (D50v) is defined as that corresponding to a volume average particle diameter.

The content of magnetic particle in the core particle may be in a range of 30% by weight to 98% by weight, is preferably in a range of 45% by weight to 95% by weight and more preferably in a range of 60% by weight to 95% by weight, in order to perform granulation or prevent mechanical loads applied to the toner.

As a resin component configuring the magnetic particle dispersed core particle, a thermoplastic resin or a thermosetting resin may be used, and examples thereof include a polyolefin resin, a polyester resin, a polycarbonate resin, a styrene resin, an acrylic resin, a styrene (meth)acrylic resin, a melamine resin, and a phenol resin.

Other components may be further contained in the core of the carrier according to the purpose. Examples of the other components include a charge-controlling agent and a fluorine-containing particle.

As a method of preparing the magnetic particle dispersed core particle, a molten kneading method of molten-kneading the magnetic particle and the resin such as the styrene acrylic resin using a BANBURY mixer and a kneader, cooling, pulverizing, and classifying the kneaded material (JP-B-S59-24416, JP-B-H8-3679, and the like), a suspension polymerization method of preparing a suspension by dispersing a monomer unit of the binder resin and the magnetic particle in a solvent and polymerizing this suspension (JP-A-H5-100493 and the like), and a spray dry method of mixing and dispersing the magnetic particle in a resin solution and spraying and drying the mixed material are known.

All of the molten kneading method, the suspension polymerization method, and the spray dry method include a process of preparing the magnetic particle by any unit, mixing the magnetic particle and the resin solution with each other, and dispersing the magnetic particle in the resin solution.

Coating Layer

The coating layer provided on the surface of the core particle described above contains a resin having a structural unit derived from a (meth)acrylic acid derivative containing a nitrogen atom (hereinafter, also referred to as a “nitrogen-containing (meth)acrylic resin”). That is, the nitrogen-containing (meth)acrylic resin is a resin obtained by at least polymerizing a (meth)acrylic acid derivative having a nitrogen atom.

In the exemplary embodiment, the (meth)acrylic acid derivative containing a nitrogen atom indicates a (meth)acrylic monomer (a monomer having a (meth)acryloyl skeleton) which has at least one nitrogen atom in the structure thereof.

The nitrogen-containing (meth)acrylic resin is a resin which has a main chain structure with the (meth)acrylic monomer and has a substituent containing a nitrogen atom in a side chain. In the nitrogen-containing (meth)acrylic resin, the nitrogen atom in the side chain may be introduced by (meth)acrylic ester containing a nitrogen atom or may be introduced by the other monomer having a nitrogen atom.

The term “(meth)acrylic” is an expression including both of “acrylic” and “methacrylic”. The term “(meth)acryloyl” is an expression including both of “acryloyl” and “methacryloyl”.

As the nitrogen-containing (meth)acrylic resin used in the exemplary embodiment, it is preferable to use (meth)acrylic ester containing a nitrogen atom as a (meth)acrylic acid derivative containing a nitrogen atom, from a viewpoint of realization of a high charging imparting ability. That is, the nitrogen-containing (meth)acrylic resin is preferably a resin obtained by polymerizing at least (meth)acrylic ester containing a nitrogen atom.

Particularly, the nitrogen-containing (meth)acrylic resin is preferably a resin containing 1% by weight or more of a structural unit derived from (meth)acrylic ester containing a nitrogen atom with respect to the weight of the nitrogen-containing (meth)acrylic resin, from a viewpoint of realization of a high charging imparting ability.

The content of the structural unit derived from (meth)acrylic ester containing a nitrogen atom in the nitrogen-containing (meth)acrylic resin is preferably equal to or greater than 3% by weight, more preferably equal to or greater than 5% by weight, and particularly preferably equal to or greater than 10% by weight with respect to the weight of the nitrogen-containing (meth)acrylic resin, from a viewpoint of realization of a higher charging imparting ability. An upper limit thereof may be 100% by weight. In a case of a copolymer, the content thereof may be equal to or smaller than 90% by weight, is preferably equal to or smaller than 80% by weight, and more preferably equal to or smaller than 70% by weight.

The nitrogen-containing (meth)acrylic resin may be a homopolymer configured with only a structural unit derived from (meth)acrylic ester containing a nitrogen atom (that is, a homopolymer of (meth)acrylic ester containing a nitrogen atom). The nitrogen-containing (meth)acrylic resin may contain structural units other than the structural unit derived from (meth)acrylic ester containing a nitrogen atom. That is, the nitrogen-containing (meth)acrylic resin may be a copolymer of (meth)acrylic ester containing a nitrogen atom and a monomer other than (meth)acrylic ester containing a nitrogen atom.

The (meth)acrylic ester containing a nitrogen atom is not particularly limited, as long as the (meth)acrylic ester has a substituent containing a nitrogen atom.

Examples of the substituent containing a nitrogen atom include an amino group, a methylamino group, a carbamoyl group, an ethylamino group, a dimethylamino group, a butylamino group, a cyclopentylamino group, a 2-ethylhexylamino group, a dodecylamino group, an anilino group, a naphthylamino group, a 2-pyridylamino group, a sulfonamide group, a sulfamoyl group, a carbamoyl group, and an amide group.

The (meth)acrylic ester containing a nitrogen atom is not particularly limited, and (meth)acrylic ester having an amino group may be used from a viewpoint of a charging imparting ability.

Specific examples thereof include dialkylaminoalkyl ester (meth)acrylate such as N, N-dimethylaminomethyl (meth)acrylate, N, N-dimethylaminoethyl (meth)acrylate, N, N-dimethylaminopropyl (meth)acrylate, N, N-diethylaminomethyl (meth)acrylate, N, N-diethylaminoethyl (meth)acrylate, N, N-diethylamino propyl (meth)acrylate, N, N-dipropylaminomethyl (meth)acrylate, N, N-dipropylaminoethyl (meth)acrylate, N, N-dipropylaminopropyl (meth)acrylate, N, N-methylethylaminomethyl (meth)acrylate, N, N-methylethyl aminoethyl (meth)acrylate, N, N-methylethylaminopropyl (meth)acrylate, N, N-methylpropylaminomethyl (meth)acrylate, N, N-methylpropylamino ethyl (meth)acrylate, N, N-methylpropylaminopropyl (meth)acrylate, N, N-ethylpropylaminomethyl (meth)acrylate, N, N-ethylpropylaminoethyl (meth)acrylate, or N, N-ethylpropylaminopropyl (meth)acrylate. Among these, dimethylaminoethyl (meth)acrylate and dimethylaminopropyl (meth)acrylate are preferably used from a viewpoint of a high charging imparting ability.

The monomer other than (meth)acrylic ester containing a nitrogen atom is not particularly limited, but the following monomers are used.

Specific examples thereof include a styrene monomer (monomer having a styrene skeleton) such as styrene, para-chloro styrene, or α-methyl styrene; a (meth)acrylic monomer (monomer having a (meth)acryloyl skeleton) such as (meth)acrylic acid, linear or branched alkyl ester of (meth)acrylic acid (methyl (meth)acrylate, ethyl (meth)acrylate, n-propyl (meth)acrylate, n-butyl (meth)acrylate, lauryl (meth)acrylate, or 2-ethylhexyl (meth)acrylate), or cyclic alkyl ester of (meth)acrylic acid (cyclohexyl (meth)acrylate or cyclopentyl (meth)acrylate); an ethylenically unsaturated nitrile monomer (a monomer having an ethylenically unsaturated nitrile skeleton) such as acrylonitrile or methacrylonitrile; a vinyl ether monomer (monomer having a vinyl ether skeleton) such as vinyl methyl ether or vinyl isobutyl ether; a vinylketone monomer (monomer having a vinylketone skeleton) such as vinyl methyl ketone, vinyl ethyl ketone, or vinyl isopropenyl ketone; and an olefin monomer (monomer having an olefin skeleton) such as ethylene, propylene, or butadiene.

The nitrogen-containing (meth)acrylic resin is preferably a homopolymer of (meth)acrylic ester having an amino group, or a copolymer of (meth)acrylic ester having an amino group and (meth)acrylic ester other than the (meth)acrylic ester having an amino group, in order to further prevent a decrease in image density. Specifically, the nitrogen-containing (meth)acrylic resin is more preferably a homopolymer of dialkylaminoalkyl ester (meth)acrylate or a copolymer of dialkylaminoalkyl ester (meth)acrylate and alkyl ester (meth)acrylate.

The alkyl ester (meth)acrylate represents a collective term of linear, branched, and cyclic alkyl ester of (meth)acrylic acid.

Specific examples of a copolymer of dialkylaminoalkyl ester (meth)acrylate and alkyl ester (meth)acrylate include a copolymer of dialkylaminoalkyl ester (meth)acrylate and linear or branched alkyl ester of (meth)acrylic acid; a copolymer of dialkylaminoalkyl ester (meth)acrylate and cyclic alkyl ester of (meth)acrylic acid; and a ternary copolymer of dialkylaminoalkyl ester (meth)acrylate, linear or branched alkyl ester of (meth)acrylic acid, and cyclic alkyl ester of (meth)acrylic acid.

A weight average molecular weight of the nitrogen-containing (meth)acrylic resin is preferably in a range of 50,000 to 140,000 and more preferably in a range of 70,000 to 120,000.

The content of the nitrogen-containing (meth)acrylic resin contained in the coating layer is preferably from 0.1% by weight to 5% by weight, more preferably from 0.2% by weight to 4% by weight, and even more preferably from 0.3% by weight to 3% by weight, with respect to the entire coating layer, from a viewpoint of realization of a high charging imparting ability.

The coating layer may contain a resin other than the nitrogen-containing (meth)acrylic resin in a range of not decreasing an effect of realization of a high charging imparting ability.

Examples of a resin other than the nitrogen-containing (meth)acrylic resin include well-known resins such as a polyolefin resin such as polyethylene or polypropylene; a polyvinyl resin such as polystyrene, acrylic resins, polyacrylonitrile, polyvinyl acetate, polyvinyl alcohol, polyvinyl butyral, polyvinyl chloride, polyvinyl carbazole, polyvinyl ether, or polyvinyl ketone; a polyvinylidene resin; a vinyl chloride-vinyl acetate copolymer; a styrene-acrylic acid copolymer; a straight silicone resin formed of an organosiloxane bond or a modified product thereof; a fluorine resin such as polytetrafluoroethylene, polyvinyl fluoride, polyvinylidene fluoride, or polychlorotrifluoroethylene; a silicone resin; polyester, polyurethane, polycarbonate; a phenol resin; an amino resin such as a urea-formaldehyde resin, a melamine resin, a benzoguanamine resin, a urea resin, or a polyamide resin; and an epoxy resin.

These resins may be used alone or in combination of two or more kinds thereof.

The content of these resins is preferably equal to or smaller than 50% by weight in the entire resin of the coating layer.

The coating layer may contain conductive particles. Herein, conductivity means volume resistivity less than 10⁷ Ω·cm.

Examples of the conductive particles include metal particles such as gold, silver, or copper; carbon black particles; semiconductor oxide particles such as titanium oxide or zinc oxide; particles having surfaces of titanium oxide, zinc oxide, barium sulfate, aluminum borate, or potassium titanate powder coated with tin oxide, carbon black, or metal; and resin particles such as melamine resin particles, urea resin particles, urethane resin particles, polyester resin particles, and acrylic resin particles.

These may be used alone or in combination of plural kinds.

A thickness of the coating layer is not particularly limited and is preferably from 0.1 μm to 3.0 μm, more preferably from 0.2 μm to 2.0 μm, and even more preferably from 0.2 μm to 1.0 μm.

The thickness of the coating layer is measured by the following method.

30 parts by weight of carrier is added and further mixed with 70 parts by weight of a mixed solution of 2 solution-type adhesive QUICK 30 (manufactured by Konishi Co., Ltd.) and cured by leaving at 25° C. for 48 hours. After forming a shape of an embedded product after the curing by a razor, the resultant product is cut by an ultra-microtome device (ULTRACUT UCT manufactured by Leica) including a diamond knife SK2035 (manufactured by Sumitomo Electric Industries, Ltd.) attached thereto (surface shaping). Cutting is performed until a smooth cut surface is formed while smoothness of the cut surface is further confirmed with an optical microscope, and a test piece is prepared. The obtained test piece is observed with a scanning electron microscope and a sectional image of the test piece is obtained. The obtained image is put into image analysis software WINROOF (manufactured by Mitani Corporation) and converted into a monochrome image, thicknesses of four portions of the coating layer for every 90 degrees in one core which is arbitrarily selected are measured, this operation is performed for 50 cores, and an arithmetic mean is calculated.

The coating amount of the coating layer with respect to the core is, for example, preferably equal to or greater than 0.5% by weight, more preferably from 0.7% by weight to 6% by weight, and even more preferably from 1.0% by weight to 5.0% by weight with respect to the weight of the entire carrier.

Herein, the coating amount is determined as follows.

When the coating layer is soluble in a solvent, the carrier is put into a soluble solvent (for example, toluene), the core is held by a magnet, and a solution in which the coating layer is dissolved is washed away. This operation is repeated several times, and accordingly, the core from which the coating layer is removed remains. The core is dried and the weight of the core is measured. A difference between the previously measured carrier amount and the core amount is divided by a carrier amount, and accordingly, the coating amount is calculated.

When the coating layer is not soluble in a solvent, the coating layer is heated at a temperature in a range of 25° C. to 1,000° C. under the nitrogen atmosphere using a differential thermobalance (for example, TG8120 manufactured by Rigaku Corporation) and the coating amount is calculated from a decreased amount of the weight thereof.

Formation of Coating Layer

As a method of forming the coating layer on the surface of the core particle, a wet preparing method or a dry preparing method is used, for example. The wet preparing method is a preparing method using a solvent which dissolves or disperses a coating resin of the coating layer. Meanwhile, the dry preparing method is a preparing method without using the solvent described above.

Examples of the wet preparing method include a dipping method of dipping and coating core particles in a coating layer forming resin solution; a spraying method of spraying a coating layer forming resin solution to surfaces of core particles; a fluid bed method of spraying a coating layer forming resin solution in a state in which core particles are allowed to float by flowing air; and a kneader-coater method in which core particles and a coating layer forming resin solution are mixed with each other in a kneader-coater and the solvent is removed.

Examples of the dry preparing method include a method of heating a mixture of core particles and a coating layer forming material in a dry state and forming a coating layer and the like. Specifically, for example, core particles and a coating layer forming material are mixed with each other in a gas phase and heated and melted, to form a coating layer.

Characteristics of Carrier

A volume average particle diameter of the carrier is, for example, from 20 μm to 200 μm, preferably from 25 μm to 60 μm, and even more preferably from 25 μm to 40 μm.

Herein, the measurement of the volume average particle diameter of the carrier is performed in the same manner as in the measurement of the volume average particle diameter of the core particles.

Regarding a magnetic force of the carrier, saturated magnetization in a magnetic field of 1,000 Oersteds is, for example, preferably equal to or greater than 40 emu/g and more preferably equal to or greater than 50 emu/g.

Herein, the measurement of the saturated magnetization of the carrier is performed using a vibration sample type magnetism-measuring device VSMP 10-15 (manufactured by Toei Industry Co., Ltd.). For example, measurement samples are put in a cell having an inner diameter of 7 mm and a height of 5 mm and are set in the device. The measurement is performed by adding the applied magnetic field, and sweeping is performed to the maximum of 3,000 Oersteds. Next, the applied magnetic field is decreased, and a hysteresis curve is created on a recording sheet. The saturated magnetization is determined from the data of the curve.

A volume electric resistance (25° C.) of the carrier may be, for example, from 1×10⁷ Ω·cm to 1×10¹⁵ Ω·cm, may be from 1×10⁸ Ω·cm to 1×10¹⁴ Ω·cm, or may be from 1×10⁸ Ω·cm to 1×10¹³ Ω·cm.

The volume electric resistance of the carrier is measured as follows. Measurement targets are loaded on a surface of a circular jig in which an electrode plate having a size of 20 cm² is arranged, so that a thickness of the measurement targets is from 1 mm to 3 mm in a smooth manner, and a layer is formed. The electrode plate having a size of 20 cm² is loaded thereon to interpose the layer. In order to remove spaces between measurement targets, 4 kg load is applied onto the electrode plate disposed on the layer and a thickness (cm) of the layer is measured. Both upper and lower electrodes of the layer are connected to an electrometer or a high-voltage power supply device. A high voltage is applied to both electrodes so that an electric field is 103.8 V/cm and a current value (A) flowing at this time is read. The measurement environment is set to have a temperature of 20° C. and humidity of 50% RH. A calculation equation of a volume electric resistance (Ω·cm) of the measurement target is as shown by the following equation.

R=E×20/(I−I₀)/L

In the above equation, R represents a volume electric resistance (Ω·cm) of a measurement target, E represents an applied voltage (V), I represents a current value (A), I₀ represents a current value (A) of an applied voltage 0 V, and L represents a thickness (cm) of a layer. A coefficient 20 represents an area (cm²) of an electrode plate.

Mixing Ratio of Toner and Carrier

In the exemplary embodiment, a mixing ratio (weight ratio) of the toner and the carrier is preferably from 1:100 to 30:100, and more preferably from 3:100 to 20:100 (toner:carrier).

Image Forming Apparatus and Image Forming Method

An image forming apparatus and an image forming method according to the exemplary embodiment will be described.

The image forming apparatus according to the exemplary embodiment includes an image holding member; a charging unit that charges the surface of the image holding member; an electrostatic charge image forming unit that forms an electrostatic charge image on the surface of the charged image holding member; a developing unit that stores an electrostatic charge image developer, and develops the electrostatic charge image formed on the surface of the image holding member as a toner image using the electrostatic charge image developer; a direct transfer type transfer unit (hereinafter, simply referred to as a “transfer unit”) that directly transfers the toner image formed on the surface of the image holding member onto the surface of a recording medium; a fixing unit that fixes the toner image transferred onto the surface of the recording medium; a cleaning unit that removes toner remaining on the surface of the surface of the image holding member; and a toner supply unit which supplies the removed toner to the developing unit. Further, as the electrostatic charge image developer, the electrostatic charge image developer according to the exemplary embodiment is applied.

In the image forming apparatus according to the exemplary embodiment, an image forming method (an image forming method according to the exemplary embodiment) including a charging process of charging the surface of an image holding member; an electrostatic charge image forming process of forming an electrostatic charge image on the surface of the charged image holding member; a developing process of developing the electrostatic charge image formed on the surface of the image holding member as a toner image using the electrostatic charge image developer; a direct transfer type transfer process (hereinafter, simply referred to as a “transfer process”) of directly transferring the toner image formed on the surface of the image holding member onto the surface of a recording medium; a fixing process of fixing the toner image transferred onto the surface of the recording medium; a cleaning process of removing toner remaining on the surface of the surface of the image holding member; and a toner supply process of supplying the removed toner to the developing unit is carried out.

As the image forming apparatus according to the exemplary embodiment, a known image forming apparatus such as an image forming apparatus that is provided with an erasing unit that irradiates, after transfer of a toner image and before charging, a surface of an image holding member with erasing light for erasing is applied.

In the image forming apparatus according to the exemplary embodiment, for example, a portion including the developing unit may have a cartridge structure (process cartridge) which is detachable from the image forming apparatus. As the process cartridge, for example, a process cartridge provided with a developing unit which stores the electrostatic charge image developer according to the exemplary embodiment is suitably used.

Hereafter, an example of the image forming apparatus according to the exemplary embodiment will be described, but the invention is not limited thereto. Further, main components shown in the drawing will be described, and the descriptions of the other components will be omitted.

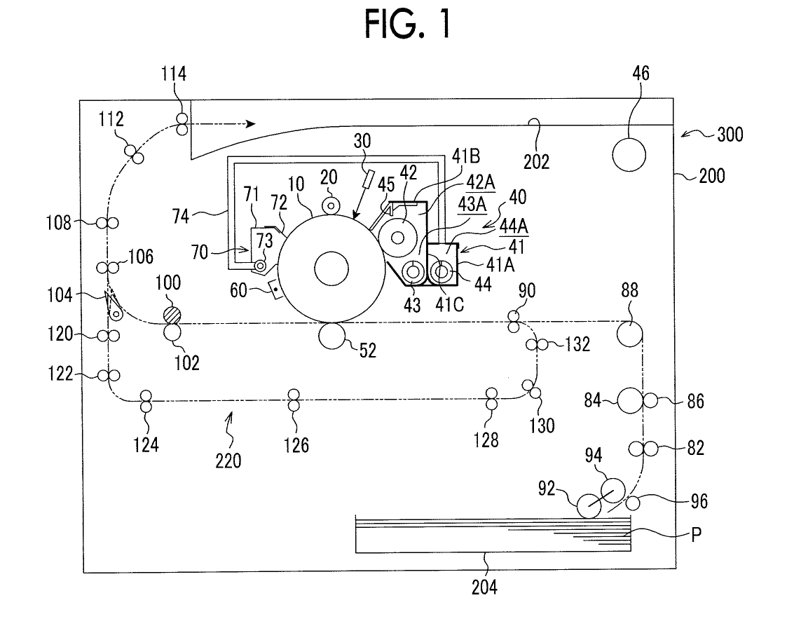

FIG. 1 is a schematic configuration diagram showing the image forming apparatus according to the exemplary embodiment.

An image forming apparatus 300 shown in FIG. 1, for example, includes a rectangular housing 200 and a paper tray 204 in which recording sheets (an example of the recording medium) P are stored and which is provided on the lower side of the housing 200. In addition, a drawing roll 92 disposed on one end side of an arm for extracting the recording sheets P stored in the paper tray 204, a roll 94 disposed on the other end side thereof, and a roll 96 disposed to oppose the roll 94 are provided.

When performing the image forming, the drawing roll 92 is moved downwards according to the position of the recording sheet P stored in the paper tray 204 and the drawing roll 92 is rotated in a state of coming into contact with the uppermost recording sheet P, and accordingly, the drawing of the recording sheet P is performed. The drawn recording sheet P is transported to the rolls 94 and 96 and is transported to be interposed between a roll pair 82 disposed on the downstream side of the roll 96 in a sheet transporting direction. A roll 84 and a roll 86 disposed to oppose each other and a roll 88 which changes the transporting direction of the recording sheet P, and a roll pair 90 are provided in this order, on the downstream side in the transporting direction of the roll pair 82.

The image forming apparatus 300 includes a cylindrical photoreceptor (an example of the image holding member) 10 which rotates clockwise on the upper side in the housing 200.

A charging roll (an example of the charging unit) 20, an exposure device (an example of the electrostatic charge image forming unit) 30, a developing device (an example of the developing unit) 40, a transfer roll (an example of the transfer unit) 52, an erasing device (an example of the erasing unit) 60, and a clearing device (an example of the cleaning unit) are provided clockwise in this order around the photoreceptor 10. Specifically, the charging roll 20 that is provided to oppose the photoreceptor 10 and charges the surface of the photoreceptor 10 to a predetermined potential, the exposure device 30 that exposes the surface of the photoreceptor 10 charged by the charging roll 20 to form an electrostatic charge image, and the developing device 40 that supplies a charged toner into the electrostatic charge image to develop the electrostatic charge image are provided around the photoreceptor 10. In addition, the transfer roll 52 that is provided to oppose the photoreceptor 10 and transfers a toner image to the recording sheet P, the erasing device 60 that irradiates the surface of the photoreceptor 10 after transferring the toner image to the transfer roll 52 with erasing light for erasing, the cleaning device 70 that cleans the surface of the photoreceptor 10 and removes the remaining toner, and the supply feeding path 74 (an example of the toner supply unit) that supplies the removed toner (collected toner) to the developing device 40 are provided. The erasing device 60 is a device provided if necessary.

As described above, the surface of the photoreceptor 10 is negatively charged by the charging roll 20 and the electrostatic charge image is formed on the surface of the charged photoreceptor 10 by the exposure device 30.

Hereinafter, the developing device 40 will be described in detail. The developing device 40 is disposed to oppose the photoreceptor 10 in a developing area, and includes a developing container 41 which stores a two-component developer formed of a toner charged to a negative (−) polarity and a carrier charged to a positive (+) polarity, for example. The developing container 41 includes a developing container main body 41A and a developing container cover 41B covering the upper end thereof.

The developing container main body 41A includes a developing roll chamber 42A that stores a developing roll 42 therein, is disposed to be adjacent to the developing roll chamber 42A, and includes a first agitating chamber 43A and a second agitating chamber 44A adjacent to the first agitating chamber 43A. A layer thickness regulation member 45 for regulating a layer thickness of the developer of the surface of the developing roll 42, when the developing container cover 41B is mounted on the developing container main body 41A, is provided in the developing roll chamber 42A.

The first agitating chamber 43A and the second agitating chamber 44A are partitioned by a partition wall 41C and the first agitating chamber 43A and the second agitating chamber 44A are connected to each other by providing openings (not shown) on both end portions of the partition wall 41C in the longitudinal direction (developing device longitudinal direction) and a circulating agitating chamber (43A+44A) is configured by the first agitating chamber 43A and the second agitating chamber 44A.

The developing roll 42 is disposed in the developing roll chamber 42A so as to oppose the photoreceptor 10 and the developing roll 42 and the photoreceptor 10 are rotated in opposite directions. The developing roll 42 is obtained by providing a sleeve at the outer side of a magnetic roll (stationary magnet). The developer of the first agitating chamber 43A is adsorbed onto the surface of the developing roll 42 by the magnetic force of the magnetic roll. A roll axis of the developing roll 42 is rotatably supported by the developing container main body 41A.

In addition, a bias supply (not shown) is connected to the sleeve of the developing roll 42, and a developing bias in which an alternating-current component (AC) is superimposed on a direct current component (DC), for example, is applied.

A first stirring member 43 (stirring and transporting member) and a second stirring member 44 (stirring and transporting member) which transport the developer while stirring the developer, are respectively disposed in the first agitating chamber 43A and the second agitating chamber 44A. The first stirring member 43 is configured with a first rotation shaft which extends in an axial direction of the developing roll 42, and an agitating and transporting blade (protrusion) fixed on the outer periphery of the rotation shaft in a spiral shape. The second stirring member 44 is also configured with a second rotation shaft and an agitating and transporting blade (protrusion) in the same manner. The stirring member is rotatably fixed to the developing container main body 41A. The first stirring member 43 and the second stirring member 44 are disposed so that the developers in the first agitating chamber 43A and the second agitating chamber 44A are transported in opposite directions by the rotation thereof.

Next, the cleaning device 70 will be described in detail. The cleaning device 70 is configured to include a housing 71, and a cleaning blade 72 disposed to protrude from the housing 71. The cleaning blade 72 is formed to have a plate shape and is provided so that a tip portion (hereinafter, also referred to as an edge portion) contacts with the photoreceptor 10. The cleaning blade 72 is provided on the downstream side of the photoreceptor 10 with respect to the transfer position due to the transfer roll 52 in the rotation direction (clockwise) and on the downstream side with respect to the position erased by the erasing device 60 in the rotation direction.

Since the photoreceptor 10 rotates clockwise, the cleaning blade 72 dams foreign materials such as toner remaining on the surface of the photoreceptor 10 without being transferred to the recording sheet P or paper powder of the recording sheet P and removes the foreign materials from the photoreceptor 10.

Herein, as the material of the cleaning blade 72, a well-known material may be used, and urethane rubber, silicone rubber, fluororubber, chloroprene rubber, or butadiene rubber may be used, for example. Among these, polyurethane is particularly preferably used, in a viewpoint of excellent abrasion resistance.

A transporting member 73 is disposed on the bottom portion of the housing 71, and one end of the supply feeding path 74 for supplying the toner (developer) removed by the cleaning blade 72 to the developing device 40 is connected to the downstream side of the housing 71 in the transporting direction of the transporting member 73. The other end of the supply feeding path 74 is connected to the developing device 40 (second agitating chamber 44A).

The cleaning device 70 supplies the toner removed by the cleaning blade 72 to the developing device 40 (second agitating chamber 44A) through the supply feeding path 74, according to the rotation of the transporting member 73 provided on the bottom portion of the housing 71. The collected toner supplied to the second agitating chamber 44A is stirred with the toner stored in the second agitating chamber 44A and is reused. The image forming apparatus 300 employs the toner reclaiming method of reusing the collected toner. The toner stored in a toner cartridge 46 is also supplied to the developing device 40 through a toner supply tube (not shown).

The recording sheet P transported to the disposed portion of the transfer roll 52 which is provided to oppose the photoreceptor 10 is pressed against the photoreceptor 10 by the transfer roll 52, and a toner image formed on the outer periphery surface of the photoreceptor 10 is transferred. A fixing device (an example of the fixing unit) including a fixing roll 100 and a roll 102 which are disposed to oppose each other, and a cam 104 are provided in this order at the downstream side of the transfer roll 52 in the sheet transporting direction. The recording sheet P to which the toner image is transferred is interposed between the fixing roll 100 and the roll 102, and the toner image is fixed thereto, and the recording sheet reaches the disposed portion of the cam 104. The cam 104 is rotatably driven by a motor (not shown), and is fixed to a position shown with a solid line or a position shown with a virtual line in FIG. 1.

When the recording sheet P reaches from the fixing roll 100 side, the cam 104 is rotatably driven to the opposite side of the fixing roll 100 (position shown with a solid line). Accordingly, the recording sheet P reaching from the fixing roll 100 side is introduced to a roll pair 106 along the outer periphery surface of the cam 104. Roll pairs 106, 108, 112, and 114 are disposed in this order at the downstream side of the cam 104 in an introducing direction of the recording sheet P in this case, and a sheet receiver 202 is disposed on the downstream side of the roll pair 114 in the sheet transporting direction.

Accordingly, the recording sheet P reaching from the fixing roll 100 side is interposed between the roll pairs 106 and 108, and when the roll pairs 106 and 108 are continuously rotated, the recording sheet P is transported to the sheet receiver 202.

When a surface of the recording sheet P where the image is formed, which is temporarily interposed between the roll pairs 106 and 108 is inverted to a back surface of the surface where the image is formed, the cam 104 is rotatably driven to the fixing roll 100 side (position shown with a virtual line). In this state, since the rotation direction of the roll pairs 106 and 108 is inverted, and the transporting direction of the recording sheet P is inverted by an inversion transporting (hereinafter, referred to as “switch-back”) method, and when the recording sheet P is transported from the roll pairs 106 and 108 side to the cam 104, the recording sheet P is introduced downwards along the outer periphery surface of the cam 104. In this case, a roll pair 120 is disposed at the downstream side of the cam 104 in the transporting direction of the recording sheet P, and the recording sheet P reaching the disposed portion of the roll pair 120 is further transported by applying a transportation force by the roll pair 120.

FIG. 1 shows a feeding path of the recording sheet P with a virtual line.

Roll pairs 122, 124, 126, 128, 130, and 132 are disposed in this order at the downstream side of the roll pair 120 in the transporting direction of the recording sheet P along the transporting path of the recording sheet P shown with a virtual line in FIG. 1, and the roll pairs configure a recording sheet inverting unit 220 with the cam 104 and the roll pairs 106, 108, and 120 described above. The recording sheet P switched-back in the disposed portions of the roll pairs 106 and 108 is transported along the transporting path shown with a virtual line in FIG. 1, reaches the disposed portion of the roll pair 90, and is transported to a nip portion between the photoreceptor 10 and the transfer roll 52, again.

At that time, as described above, the recording sheet P is switched-back in the recording sheet inverting unit 220. Accordingly, when the back surface of the surface where the image is previously formed is inverted so that the back surface faces the photoreceptor 10 side, and the toner image is transferred to this back surface and is fixed thereto by the fixing roll 100, the image is formed on both surfaces. The recording sheet P having the image formed on both surfaces thereof is discharged to the sheet receiver 202 so that the surface where the image is formed later is at the back side. When the image is not formed on the recording sheet P in the later image forming (image forming after the recording sheet P is inverted in the recording sheet inverting unit), the recording sheet P is discharged to the sheet receiver 202 so that the surface where the image is previously formed is at the front side.

Examples of the recording sheet P onto which a toner image is transferred include plain paper that is used in electrophotographic copying machines, printers, and the like. As a recording medium, an OHP sheet is also exemplified other than the recording sheet P. As the recording sheet P, for example, coating paper obtained by coating a surface of plain paper with a resin or the like, art paper for printing, and the like are preferably used.

Process Cartridge/Developer Cartridge

A process cartridge according to the exemplary embodiment will be described.

The process cartridge according to the exemplary embodiment is provided with a developing unit that stores the electrostatic charge image developer according to the exemplary embodiment and develops an electrostatic charge image formed on a surface of an image holding member with the electrostatic charge image developer to form a toner image, and is detachable from an image forming apparatus.

The process cartridge according to the exemplary embodiment is not limited to the above-described configuration, and may be configured to include a developing device, and if necessary, at least one selected from other units such as an image holding member, a charging unit, an electrostatic charge image forming unit, and a transfer unit.

Hereinafter, an example of the process cartridge according to the exemplary embodiment will be shown. However, this process cartridge is not limited thereto. Major parts shown in the drawing will be described, but descriptions of other parts will be omitted.

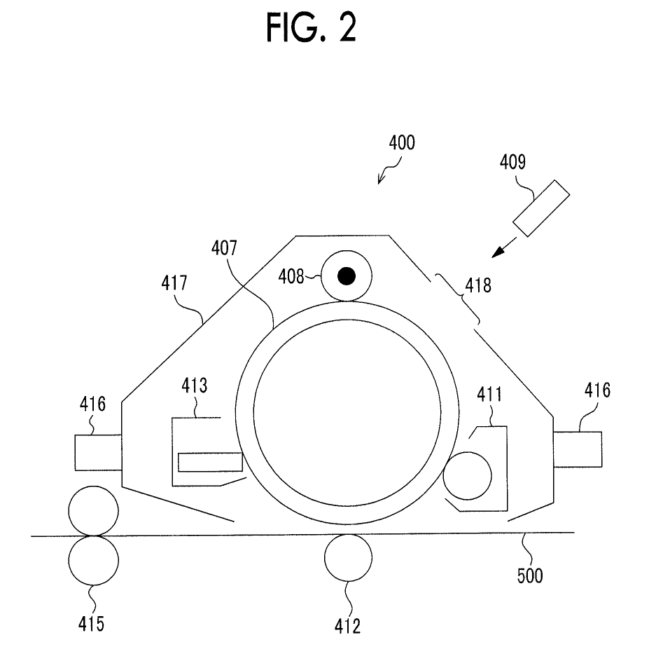

FIG. 2 is a configuration diagram showing a configuration of the process cartridge according to the exemplary embodiment.

A process cartridge 400 shown in FIG. 2 is formed as a cartridge having a configuration in which a photoreceptor (an example of the image holding member) 407, and a charging roll (an example of the charging unit) 408, a developing device (an example of the developing unit) 411, and a photoreceptor cleaning device (an example of the cleaning unit) 413, which are provided around the photoreceptor 407, are integrally combined and held by the use of, for example, a housing 417 provided with a mounting rail 416 and an opening 418 for exposure.

In FIG. 2, the reference numeral 409 represents an exposure device (an example of the electrostatic charge image forming unit), the reference numeral 412 represents a transfer device (an example of the transfer unit), the reference numeral 415 represents a fixing device (an example of the fixing unit), and the reference numeral 500 represents a recording sheet (an example of the recording medium). In FIG. 2, a mechanism of toner reclaiming of supplying and reusing the toner removed by the photoreceptor cleaning device 413 to the developing device 411 through the supply feeding path (an example of the toner supply unit), for example, is omitted.

Next, a developer cartridge according to the exemplary embodiment will be described.

The developer cartridge according to the exemplary embodiment stores the developer according to the exemplary embodiment and is detachable from an image forming apparatus. The developer cartridge according to the exemplary embodiment may include a storing portion that stores the electrostatic charge image developer according to the exemplary embodiment

As the carrier according to the exemplary embodiment, a so-called trickle developing carrier which performs development while switching the carrier stored in the developing unit is also preferably used. For example, as an image forming apparatus shown in FIG. 1, a trickle type image forming apparatus which changes the toner cartridge 46 to the developer cartridge according to the exemplary embodiment, replenishes the developing device 40 with the developer, and performs development while switching the electrostatic charge image developing carrier stored in the developing device 40 may be used.

An amount of the carrier according to the exemplary embodiment in the developer contained in the developer cartridge is preferably equal to or smaller than 20% by weight and more preferably from 1% by weight to 10% by weight of the toner amount, because, as the carrier amount increases, a variation in the carrier amount used for replenishment of the developing device 40 increases.

In addition, a cartridge which only stores a replenishment toner and a cartridge which only stores the carrier according to the exemplary embodiment may be separately provided.

### EXAMPLE

Hereinafter, examples will be described but the invention is not limited to the examples. In the following description, unless specifically noted, “parts” and “%” are based on weight.

Preparation of Polyester Resin Particle Dispersion Preparation of Polyester Resin Particle Dispersion (1)
2.2 mol ethylene oxide adduct of bisphenol A: 45 parts by mol
2.2 mol propylene oxide adduct of bisphenol A: 55 parts by mol
Dimethyl terephthalate: 55 parts by mol
Dimethyl fumarate: 15 parts by mol
Dodecenyl succinic anhydride: 20 parts by mol
Trimellitic anhydride: 5 parts by mol

The monomers of the monomers described above except for dimethyl fumarate and trimellitic anhydride, and 0.25 part of dioctanoic acid tin with respect to 100 parts of total monomers described above are put in a reaction vessel equipped with a stirrer, a thermometer, a condenser and a nitrogen gas introducing tube. Under the nitrogen gas flow, the mixture is subjected to a reaction at 235° C. for 6 hours, and then the temperature is dropped to 200° C., dimethyl fumarate and trimellitic anhydride are added thereto and subjected to a reaction for 1 hour. The resultant mixture is heated to 220° C. over 5 hours, and is polymerized under the pressure of 10 kPa until a predetermined molecular weight is obtained, and thus, a light yellow transparent polyester resin (1) is obtained.

Regarding the obtained polyester resin (1), a weight average molecular weight is 36,000, a number average molecular weight is 8,500, and a glass transition temperature is 60° C.

Next, the obtained polyester resin (1) is dispersed using a dispersing device prepared by modifying CAVITRON CD1010 (manufactured by Eurotec Co., Ltd.) to a high temperature and high pressure type. A solution containing an ion exchange water and the polyester resin in a composition ratio of 80% and 20%, respectively, is prepared. After the pH is adjusted to 8.5 with ammonia, the solution is treated by operating CAVITRON under the conditions of a rotation rate of a rotator of 60 Hz, a pressure of 5 kg/cm², and heating to 140° C. by a heat exchanger, and thus, a polyester resin particle dispersion (1) (solid content of 20%) is obtained.

Preparation of Polyester Resin Particle Dispersion (2)
1,10-dodecanedioic acid: 50 parts by mol
1,9-nonanediol: 50 parts by mol

The monomers are put in a reaction vessel including a stirrer, a thermometer, a condenser, and a nitrogen gas introducing tube, the atmosphere in the reaction vessel is substituted with dry nitrogen gas, and 0.25 part of titanium tetrabutoxide (reagent) with respect to 100 parts of the monomers is added thereto. Under the nitrogen gas flow, the mixture is stirred and subjected to a reaction at 170° C. for 3 hours, and is further heated to 210° C. over 1 hour, the pressure in the reaction vessel is reduced to 3 kPa, the mixture is stirred and subjected to a reaction under the reduced pressure for 13 hours, and thus, a polyester resin (2) is obtained.

Regarding the polyester resin (2), a weight average molecular weight is 26,000, a number average molecular weight is 10,500, an acid value is 10.3 mgKOH/g, and a melting temperature measured by DSC is 73.1° C.

Next, the obtained polyester resin (2) is dispersed using a dispersing device obtained by modifying CAVITRON CD1010 (manufactured by Eurotec Co., Ltd.) to a high temperature and high pressure type. CAVITRON is operated under the conditions of a composition ratio in which concentration of ion exchange water is 80% and concentration of the polyester resin is 20%, pH which is adjusted to 8.5 by ammonia, a rotation rate of a rotator of 60 Hz, pressure of 5 kg/cm², and heating to 140° C. by a heat exchanger, and thus, a polyester resin particle dispersion (2) (solid content of 20%) is obtained.

Preparation of Styrene Acrylic Resin Particle Dispersion Preparation of Styrene Acrylic Resin Particle Dispersion (1)
Styrene: 78 parts
n-butyl acrylate: 22 parts
1,10-decanediol diacrylate: 0.4 parts
Dodecanethiol: 0.7 parts

A solution obtained by dissolving 1.0 part of an anionic surfactant (DOWFAX manufactured by The Dow Chemical Company) in 60 parts of ion exchange water is added to a mixture obtained by mixing and dissolving the above components, and the resultant mixture is dispersed and emulsified in a flask, to prepare an emulsion.

Then, 2.0 parts of an anionic surfactant (DOWFAX manufactured by The Dow Chemical Company) is dissolved in 90 parts of ion exchange water, 20 parts of the emulsion is added thereto, and 10 parts of ion exchange water in which 1.0 part of ammonium persulfate are dissolved is put thereto.

Next, after putting residual of the emulsion over 3 hours and performing nitrogen substitution in the flask, the solution is heated to be 65° C. in an oil bath while stirring the solution in the flask, emulsification and polymerization are continued for 5 hours as it is, and a styrene acrylic resin particle dispersion (1) having solid content adjusted to 32% is obtained.

Preparation of Styrene Acrylic Resin Particle Dispersion (2)

A styrene acrylic resin particle dispersion (2) having solid content of 32% is obtained in the same manner as in the preparation of the styrene acrylic resin particle dispersion (1), except for changing 2.0 parts of the anionic surfactant (DOWFAX manufactured by The Dow Chemical Company) contained in the solution to which 20 parts of the emulsion is to be added, to 3.0 parts and changing 20 parts of the emulsion is to be added to 30 parts.

Preparation of Styrene Acrylic Resin Particle Dispersion (3)

A styrene acrylic resin particle dispersion (3) having solid content of 32% is obtained in the same manner as in the preparation of the styrene acrylic resin particle dispersion (1), except for changing 2.0 parts of the anionic surfactant (DOWFAX manufactured by The Dow Chemical Company) contained in the solution to which 20 parts of the emulsion is to be added, to 1.5 parts.

Preparation of Styrene Acrylic Resin Particle Dispersion (4)

A styrene acrylic resin particle dispersion (4) having solid content of 32% is obtained in the same manner as in the preparation of the styrene acrylic resin particle dispersion (1), except for changing 2.0 parts of the anionic surfactant (DOWFAX manufactured by The Dow Chemical Company) contained in the solution to which 20 parts of the emulsion is to be added, to 4.0 parts and changing 20 parts of the emulsion to be added to 40 parts.

Preparation of Styrene Acrylic Resin Particle Dispersion (5)

A styrene acrylic resin particle dispersion (5) having solid content of 32% is obtained in the same manner as in the preparation of the styrene acrylic resin particle dispersion (1), except for changing 2.0 parts of the anionic surfactant (DOWFAX manufactured by The Dow Chemical Company) contained in the solution to which 20 parts of the emulsion is to be added, to 1.2 parts.

Herein, the volume average particle diameter of the particles in each styrene acrylic resin particle dispersion is shown in Table 1 as a list.

In Table 1, “St-Ac dispersion” indicates the styrene acrylic resin particle dispersion.

TABLE 1

| | Volume average |
|---|---|
| St-Ac | particle |
| dispersion No. | diameter (nm) |
| (1) | 120 |
| (2) | 90 |
| (3) | 150 |
| (4) | 80 |
| (5) | 170 |

Preparation of Colorant Particle Dispersion

Preparation of Colorant Particle Dispersion (1)
Carbon black (REGAL 330 manufactured by Cabot Corporation.): 250 parts
Anionic surfactant (NEOGEN SC manufactured by DKS Co. Ltd.): 33 parts (60% of active ingredient, 8% with respect to the colorant)
Ion exchange water: 750 parts

280 parts of ion exchange water and 33 parts of anionic surfactant are put in a stainless steel vessel having such a size that a height of a liquid surface when all of the above components are put therein is approximately ⅓ of the height of the vessel, the surfactant is sufficiently dissolved, the solid solution pigments are all put therein, the resultant material is stirred using a stirrer until no unwet pigments remain, and sufficiently defoamed. The remaining ion exchange water is added thereto after the defoaming, the resultant material is dispersed by using a homogenizer (ULTRA TURRAX T50 manufactured by IKA Japan, K.K.) at 5,000 rpm for 10 minutes, is stirred and defoamed using the stirrer for 24 hours. After the defoaming, the resultant material is dispersed again by using the homogenizer at 6,000 rpm for 10 minutes, is stirred and defoamed using the stirrer for 24 hours. Then, the dispersion is dispersed by using a high pressure impact type dispersing machine ULTIMIZER (HJP30006 manufactured by Sugino Machine Limited.) at pressure of 240 MPa. The dispersion is performed to be equivalent to 25 passes with the conversion from the total introduction amount and processing capacity of the device. The obtained dispersion is allowed to stand for 72 hours to remove precipitates, ion exchange water is added thereto to adjust a solid content concentration to 15%, and thus, a colorant particle dispersion (1) is obtained.

Preparation of Release Agent Particle Dispersion

Preparation of Release Agent Particle Dispersion (1)
Polyethylene wax (hydrocarbon wax: product name “POLYWAX 725 (manufactured by Baker Petrolite Corporation.)”, melting temperature of 104° C.): 270 parts
Anionic surfactant (NEOGEN RK manufactured by DKS Co. Ltd., active ingredient amount: 60%): 13.5 parts (3.0% of active ingredient with respect to the release agent)
Ion exchange water: 21.6 parts

After mixing the above components and dissolving the release agent by using a pressure discharge type homogenizer (GAULIN HOMOGENIZER manufactured by Gaulin) at an internal liquid temperature of 120° C., dispersion process is performed at a dispersion pressure of 5 Mpa for 120 minutes and then at a dispersion pressure of 40 MPa for 360 minutes, the mixture is cooled, and a release agent particle dispersion (1) is obtained. After that, ion exchange water is added thereto to adjust a solid content concentration to 20%.

Preparation of Release Agent Particle Dispersion (2)

A release agent particle dispersion (2) is obtained in the same manner as in the preparation of the release agent particle dispersion (1), except for changing polyethylene wax to polyethylene wax (hydrocarbon wax: product name “POLYWAX 1000 (manufactured by Baker Petrolite Corporation), melting temperature of 113° C.”).

Preparation of release agent particle dispersion (3)

A release agent particle dispersion (3) is obtained in the same manner as in the preparation of the release agent particle dispersion (1), except for changing polyethylene wax to paraffin wax (hydrocarbon wax: product name “HNP 9 (manufactured by Nippon Seiro Co., Ltd.)”, melting temperature of 75° C.)

Preparation of Mixed Particle Dispersion

Preparation of Mixed Particle Dispersion (1)

After mixing 400 parts of the polyester resin particle dispersion (1), 60 parts of the release agent particle dispersion (1), and 2.9 parts of the anionic surfactant (DOWFAX2A1 manufactured by The Dow Chemical Company) with each other, 1.0% nitric acid is added thereto at 25° C. to adjust pH to 3.0, and thus, a mixed particle dispersion (1) is obtained.

Preparation of Toner Particles

Preparation of Toner Particles (1)
Polyester resin particle dispersion (1): 700 parts
Polyester resin particle dispersion (2): 50 parts
Styrene acrylic resin particle dispersion (1): 205 parts
Release agent particle dispersion (1): 15 parts
Colorant particle dispersion (1): 133 parts
Ion exchange water: 600 parts
Anionic surfactant (DOWFAX2A1 manufactured by The Dow Chemical Company): 2.9 parts

After putting the above components in a 3-liter reaction vessel equipped with a thermometer, a pH meter and a stirrer, and adding 1.0% nitric acid at 25° C. to adjust the pH to 3.0, 100 parts of the aluminum sulfate aqueous solution having concentration of 2% as an aggregating agent is added thereto while performing dispersion using a homogenizer (ULTRA TURRAX T50 manufactured by IKA Japan, K.K.) at 3,000 rpm.

Viscosity of a raw material dispersion rapidly increases while the aggregating agent is added dropwise. Accordingly, the dropwise-addition speed is reduced at the time of an increase in viscosity, to prevent the aggregating agent from being localized to one portion. At the time when the dropwise addition of the aggregating agent is finished, the rotation rate is increased to 5,000 rpm to perform stirring for 5 minutes.

After that, a stirrer and a mantle heater are installed in the reaction vessel, the temperature is raised at a rate of temperature rise of 0.2° C./min up to 40° C. and at a rate of temperature rise of 0.05° C./min when the temperature is higher than 40° C. and equal to or lower than 53° C., while adjusting the rotation rate of the stirrer so that the slurry is sufficiently stirred, and a particle diameter is measured using COULTER MULTISIZER II (manufactured by Beckman Coulter, Inc., aperture size: 50 μm) for every 10 minutes. The temperature is kept when a volume average particle diameter is 5.0 μm, and 460 parts of the mixed particle dispersion (1) is put therein over 5 minutes.

After keeping the resultant mixture at 50° C. for 30 minutes, 8 parts of 20% solution of ethylenediaminetetraacetic acid (EDTA) with respect to the total amount of the dispersion put in the reaction vessel is added thereto, 1 mol/liter of sodium hydroxide aqueous solution is added to adjust the pH of the raw material dispersion to 9.0. After that, the resultant material is heated to 90° C. at the rate of temperature rise of 1° C./min while adjusting pH to 9.0 for every time when the temperature rises 5° C., and the temperature is kept at 90° C. When a particle shape and a surface property are observed with an optical microscope and a field emission type scanning electron microscope (FE-SEM), coalescence of the particles is confirmed when 6 hours has elapsed, and accordingly the vessel is cooled with cooling water to 30° C. over 5 minutes.

The cooled slurry passes through nylon mesh of a mesh size of 15 μm to remove coarse powder, and toner slurry which has passed through the mesh is filtrated using an aspirator under the reduced pressure. The solid content remaining on filter paper is pulverized into pieces as small as possible, and put into the ion exchange water having an amount of 10 times the amount of the solid content at 30° C. and stirred and mixed for 30 minutes. Next, the mixture is filtrated using an aspirator under the reduced pressure, the solid content remaining on the filter paper is pulverized into pieces as small as possible, and put into the ion exchange water having an amount of 10 times the amount of the solid content at 30° C. and stirred and mixed for 30 minutes. After that the mixture is filtrated again using an aspirator under the reduced pressure, and electrical conductivity of the filtrate is measured. This operation is repeated until the electrical conductivity of the filtrate becomes equal to or less than 10 μS/cm, and the solid content is washed.

The washed solid content is pulverized into small pieces with a wet type and dry-type granulator (Comil), is subjected to vacuum drying in an oven at 35° C. for 36 hours, and toner particles (1) are obtained. A volume average particle diameter of the toner particles (1) is 6.0 μm.

Preparation of Toner Particles (2) to (8)

Toner particles (2) to (8) are obtained by changing the kind of the styrene acrylic resin particle dispersion and the kind of the release agent according to Table 2. A list is shown in Table 2.

In Table 2, a “St-Ac dispersion” indicates a styrene acrylic resin particle dispersion. “none” indicates no addition of a styrene acrylic resin particle dispersion.

TABLE 2

| | | Release agent |
|---|---|---|
| Toner | St-Ac | particle |
| particle No. | dispersion No. | dispersion No. |
| (1) | (1) | (1) |
| (2) | (2) | (1) |
| (3) | (3) | (1) |
| (4) | (1) | (2) |
| (5) | (1) | (3) |
| (6) | None | (1) |
| (7) | (5) | (1) |
| (8) | (4) | (1) |

Preparation of External Additive

Preparation of Silica Particles (1)

150 parts of 25% ammonia aqueous solution is added dropwise to 150 parts of tetramethoxysilane in the presence of 100 parts of ion exchange water and 100 parts of 25% alcohol at 30° C. over 4 hours while stirring at 130 rpm. Centrifugation of a silica sol suspension obtained by this reaction is performed to separate the silica sol suspension into wet silica gel, alcohol, and ammonia aqueous solution, the separated wet silica gel is further dried at 120° C. for 2 hours, 100 parts of silica and 500 parts of ethanol are put into an evaporator and stirred for 15 minutes while maintaining a temperature to 40° C. Then, 10 parts of dimethyldimethoxysilane is put into 100 parts of silica and further stirred for 15 minutes. At last, the temperature is increased to 90° C. to dry ethanol under the reduced pressure, the processed product is taken out and further subjected to vacuum drying at 120° C. for 30 minutes. The dried silica is pulverized, and thus, silica particles (1) having a volume average particle diameter of 150 nm are obtained.

Silica Particles (2)

As silica particles (2), silica particles (RX50 manufactured by Nippon Aerosil Co., Ltd.) subjected to surface hydrophobization treatment with hexamethyldisilazane (HMDS) are prepared.

Preparation of Titania Particles (1)

An ilmenite ore (FeTiO₂) is heated and dissolved in concentrated sulfuric acid to separate iron powder, and TiOSO₄ is obtained. A precipitate of TiO(OH)₂ is formed by heating and hydrolysis, filtered, repeatedly subjected to water washing, and dried at 150° C. Heating and sintering are performed under the conditions at 750° C. for 120 minutes and titanium oxide is obtained. The obtained titanium oxide is dispersed in water and 5% by weight of solid content of isobutyl trimethoxysilane is added dropwise at 25° C. while stirring. This is filtered and repeatedly subjected to water washing. The titanium oxide subjected to surface treatment with the obtained isobutyl methoxysilane is dried at 150° C. and titania particles (1) having a volume average particle diameter of 85 nm are prepared.

Preparation of Carrier

Preparation of Carrier (1)

After adding 500 parts by weight of spherical magnetite particle powder having a volume average particle diameter of 0.22 μm into a HENSCHEL mixer and sufficiently stirring, 4.5 parts by weight of a titanate coupling agent is added thereto, and the resultant is heated to 95° C. and mixed and stirred for 30 minutes, thereby obtaining spherical magnetite particles coated with the titanate coupling agent. Then, 6.5 parts by weight of phenol, 10 parts by weight of 30% formalin, 500 parts by weight of the magnetite particles, 7 parts by weight of 25% ammonia aqueous solution, and 400 parts by weight of water are put into a 1-liter four-necked flask, and are mixed and stirred. After heating the mixture to 85° C. over 60 minutes while stirring and performing the reaction at the same temperature for 180 minutes, the mixture is cooled to 25° C., 500 ml of water is added thereto, a supernatant is removed, and a precipitate is washed with water. This is dried at 180° C. under the reduced pressure, coarse powder is removed with a sieve having an aperture of 106 μm, and thus, core particles (A) having an average particle diameter of 32 μm are obtained.
Core particles (A): 100 parts
Toluene: 15 parts
Dimethylaminoethyl methacrylate (DMAEMA)/cyclohexyl methacrylate (CHMA) resin (copolymer): 2.5 parts (copolymerization ratio: DMAEMA/CHMA=0.05 parts/2.45 parts, weight average molecular weight of 100,000)
Resin particles: 0.25 parts

(melamine resin particles, volume average particle diameter of 100 nm)

The above components excluding the core particles (A) are dispersed by a homomixer for 3 minutes and a coating layer forming resin solution is prepared. After stirring the coating layer forming resin solution and the core particles (A) prepared as described above in a vacuum deaeration kneader kept at 60° C. for 15 minutes, toluene is distilled away by reducing pressure to 5 kPa for 15 minutes, and thus, a carrier (1) is obtained.

Preparation of Carrier (2)

A carrier (2) is obtained in the same manner as in the preparation of the carrier (1), except for preparing the core particles (B) by changing magnetite particles of the core particles (A) to spherical magnetite particles having a volume average particle diameter of 0.65 μm.

Preparation of Carrier (3)
Core particles (A): 100 parts
Toluene: 15 parts
Dimethylaminoethyl methacrylate (DMAEMA) resin: 2.5 parts

(weight average molecular weight of 120,000)
Resin particles: 0.25 parts

(melamine resin particles, volume average particle diameter of 100 nm)

The above components excluding the core particles (A) are dispersed by a homomixer for 3 minutes and a coating layer forming resin solution is prepared. After stirring the coating layer forming resin solution and the core particles (A) prepared as described above in a vacuum deaeration kneader kept at 60° C. for 15 minutes, toluene is distilled away by reducing pressure to 5 kPa for 15 minutes, and thus, a carrier (3) is obtained.

Preparation of Carrier (4)
Ferrite particles: 100 parts

(Mn—Mg ferrite, BET specific surface area of 0.09 g/m², volume average particle diameter of 34 μm)
Toluene: 15 parts
Styrene-methyl methacrylate resin (copolymer): 2.5 parts

(weight average molecular weight of 110,000)
Resin particles: 0.25 parts

(melamine resin particles, volume average particle diameter of 100 nm)

The above components excluding the ferrite particles are dispersed by a homomixer for 3 minutes and a coating layer forming resin solution is prepared. After stirring the coating layer forming resin solution and the ferrite particles in a vacuum deaeration kneader kept at 60° C. for 15 minutes, toluene is distilled away by reducing pressure to 5 kPa for 15 minutes, and thus, a carrier (4) having a coating layer is obtained.

Preparation of Carrier (5)
Ferrite particles: 100 parts

(Mn—Mg ferrite, BET specific surface area of 0.09 g/m², volume average particle diameter of 34 μm)
Toluene: 15 parts
Dimethylaminoethyl methacrylate (DMAEMA) resin: 2.5 parts

(weight average molecular weight of 120,000)
Resin particles: 0.25 parts

(melamine resin particles, volume average particle diameter of 100 nm)

The above components excluding the ferrite particles are dispersed by a homomixer for 3 minutes and a coating layer forming resin solution is prepared. After stirring the coating layer forming resin solution and the ferrite particles in a vacuum deaeration kneader kept at 60° C. for 15 minutes, toluene is distilled away by reducing pressure to 5 kPa for 15 minutes, and thus, a carrier (5) having a coating layer is obtained.

Preparation of Carrier (6)
Core particles (A): 100 parts
Toluene: 15 parts
Styrene-methyl methacrylate resin (copolymer): 2.5 parts

(weight average molecular weight of 110,000)
Resin particles: 0.25 parts

(melamine resin particles, volume average particle diameter of 100 nm)

The above components excluding the core particles (A) are dispersed by a homomixer for 3 minutes and a coating layer forming resin solution is prepared. After stirring the coating layer forming resin solution and the core particles (A) in a vacuum deaeration kneader kept at 60° C. for 15 minutes, toluene is distilled away by reducing pressure to 5 kPa for 15 minutes, and thus, a carrier (6) having a coating layer is obtained.

### Example 1

### Preparation of Developer (1)

100 parts of the toner particles (1) and 1.5 parts of the silica particles (1) are mixed with each other using a HENSCHEL mixer (a circumferential speed of 30 m/s for 3 minutes) and a toner (1) is obtained.

9 parts of the toner (1) is mixed with 100 parts of the carrier (1) and thus, a developer (1) is obtained.

### Examples 2 to 10 and Comparative Examples 1 to 5

Developers (1) to (10) and (C1) to (C5) are obtained by changing the kind of toner particles, the kind of external additive, and the kind of carrier according to Table 3.

Evaluation

Average Diameter of Domains

Regarding the toner of the developer obtained in each example, an average diameter of the domains of the styrene (meth)acrylic resin is measured according to the method described above.

Evaluation of Image Density

The developer obtained in each example is stored in a modified apparatus of 700 DIGITAL COLOR PRESS manufactured by Fuji Xerox Co., Ltd. and a printing test of an image is performed. Evaluation is started after leaving the developer in the high temperature and high humidity environment (28° C. and 85%) for one day. Premier TCF 80 gsm is used as a sheet and solid images having an area coverage of 20% are continuously printed on both surfaces of 100,000 sheets. The image density of tenth sheet and image density of 100,000th sheet are measured using an image densitometer (X-RITE 404A: manufactured by X-Rite, Incorporated.) and a difference in measured results of the image density is determined to perform the evaluation of the image density. Levels up to C are acceptable ranges.

Evaluation Criteria of Image Density

A: image density of 100,000th sheet is equal to or greater than 97% with respect to tenth sheet.

B: image density of 100,000th sheet is equal to or greater than 94% and less than 97% with respect to tenth sheet.

C: image density of 100,000th sheet is equal to or greater than 90% and less than 94% with respect to tenth sheet.

D: image density of 100,000th sheet is less than 90 with respect to tenth sheet.

Evaluation of Fogging and Black Spots

Regarding 100 sheets from 99,900th to 100,000th sheet used in the evaluation of the image density, the evaluation of fogging and evaluation of black spots of a non-image portion are performed.

Evaluation Criteria of Fogging

A: fogging is not observed.

B: fogging is slightly observed.

C: fogging is observed but is in an acceptable range.

Evaluation Criteria of Black Spots

A: black spots are not observed.

B: black spots are slightly observed.

C: black spots are observed but are in an acceptable range.

Evaluation of Peeling Properties

Solid images (front edge solid images) are formed in an area of the front edge in a sheet proceeding direction and letters (rear edge letters) are formed in an area of the rear edge in the sheet proceeding direction on both surfaces of 100 sheets using the developer used in the evaluation of the image density. The offset of Premier TCF 80 gsm paper to which the front edge solid images and the rear edge letters are fixed (phenomenon in which the image formed on the surface of the sheet is attached to the fixing member) is visually observed. Evaluation criteria are as follows.

Evaluation Criteria

A: peeling is particularly excellent and no offset occurs in the front edge solid images and the rear edge letter portions.

B: no offset occurs in the front edge solid images and the rear edge letter portions.

C: images and letters are peeled by using a peeling claw and this is in an acceptable level.

TABLE 3

| | | Toner particles | | External additives | | | |
|---|---|---|---|---|---|---|---|
| | | Toner | St-Ac resin | Silica | | Titania | |
| | Developer | particle | domain | | Amount | | Amount |
| | No. | No. | diameter (nm) | No. | (parts) | No. | (parts) |
| Example 1 | (1) | (1) | 560 | (1) | 1.5 | None | 0 |
| Example 2 | (2) | (2) | 320 | (1) | 1.5 | None | 0 |
| Example 3 | (3) | (3) | 780 | (1) | 1.5 | None | 0 |
| Example 4 | (4) | (4) | 560 | (1) | 1.5 | None | 0 |
| Example 5 | (5) | (5) | 560 | (1) | 1.5 | None | 0 |
| Example 6 | (6) | (1) | 560 | (1) | 1.5 | None | 0 |
| Example 7 | (7) | (1) | 560 | (1) | 1.5 | None | 0 |
| Example 8 | (8) | (1) | 560 | (2) | 1.5 | None | 0 |
| Example 9 | (9) | (1) | 560 | None | 0 | (1) | 1.0 |
| Example 10 | (10) | (1) | 560 | (1) | 1.5 | (1) | 1.0 |
| Comparative | (C1) | (6) | None | (1) | 1.5 | None | 0 |
| Example 1 | | | | | | | |
| Comparative | (C2) | (1) | 560 | (1) | 1.5 | None | 0 |
| Example 2 | | | | | | | |
| Comparative | (C3) | (1) | 560 | (2) | 1.5 | None | 0 |
| Example 3 | | | | | | | |
| Comparative | (C4) | (7) | 900 | (1) | 1.5 | None | 0 |
| Example 4 | | | | | | | |
| Comparative | (C5) | (8) | 280 | (1) | 1.5 | None | 0 |
| Example 5 | | | | | | | |

| | Carrier | | | Evaluation | | | |
|---|---|---|---|---|---|---|---|
| | Carrier | | Nitrogen-containing | Image | Peeling | | Black |
| | No. | Core | Ac resin | density | properties | Fogging | spots |
| Example 1 | (1) | Magnetic particle | Contained | A | A | A | A |
| | | dispersion | | | | | |
| Example 2 | (1) | Magnetic particle | Contained | A | A | B | B |
| | | dispersion | | | | | |
| Example 3 | (1) | Magnetic particle | Contained | B | B | A | A |
| | | dispersion | | | | | |
| Example 4 | (1) | Magnetic particle | Contained | B | C | B | B |
| | | dispersion | | | | | |
| Example 5 | (1) | Magnetic particle | Contained | C | A | C | C |
| | | dispersion | | | | | |
| Example 6 | (2) | Magnetic particle | Contained | B | A | B | C |
| | | dispersion | | | | | |
| Example 7 | (3) | Magnetic particle | Contained | C | A | A | A |
| | | dispersion | | | | | |
| Example 8 | (1) | Magnetic particle | Contained | B | A | C | C |
| | | dispersion | | | | | |
| Example 9 | (1) | Magnetic particle | Contained | C | C | C | C |
| | | dispersion | | | | | |
| Example 10 | (1) | Magnetic particle | Contained | A | B | A | A |
| | | dispersion | | | | | |
| Comparative | (4) | Magnetic particles | None | D | C | C | C |
| Example 1 | | | | | | | |
| Comparative | (5) | Magnetic particles | Contained | D | A | C | C |
| Example 2 | | | | | | | |
| Comparative | (6) | Magnetic particle | None | D | A | C | C |
| Example 3 | | dispersion | | | | | |
| Comparative | (1) | Magnetic particle | Contained | D | B | C | C |
| Example 4 | | dispersion | | | | | |
| Comparative | (1) | Magnetic particle | Contained | D | C | C | C |
| Example 5 | | dispersion | | | | | |

In a toner particle column of Table 3, the “St-Ac resin domain diameter” indicates an average domain diameter of the styrene (meth)acrylic resin in the toner particle.

In a carrier column of Table 3, the “nitrogen-containing Ac resin” indicates a resin having a structural unit derived from a (meth)acrylic acid derivative containing a nitrogen atom.

From the above results, it is found that excellent results are obtained in the evaluation of the image of Examples, compared to Comparative Examples. Therefore, it is found that a decrease in image density is prevented in Examples, compared to Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developer comprising:
an electrostatic charge image developing toner including toner particles and an external additive; and
a carrier,
wherein the toner particle contains a polyester resin and a styrene (meth)acrylic resin and includes domains of the styrene (meth)acrylic resin having an average diameter of 300 nm to 800 nm, and
the carrier includes a magnetic particle dispersed core particle and a (meth)acrylic resin which contains a nitrogen atom on the surface of the core particle.

2. The electrostatic charge image developer according to claim 1,
wherein a content of the styrene (meth)acrylic resin is in a range of 10% by weight to 30% by weight with respect to the toner particle.

3. The electrostatic charge image developer according to claim 1,
wherein a content of the styrene (meth)acrylic resin is in a range of 15% by weight to 25% by weight with respect to the toner particle.

4. The electrostatic charge image developer according to claim 1,
wherein the domains of the styrene (meth)acrylic resin are domains having an average diameter of 400 nm to 700 nm.

5. The electrostatic charge image developer according to claim 1,
wherein a percentage of the number of domains of the styrene (meth)acrylic resin having a diameter which is in a range of ±0.1 μm from an average diameter of the domains is equal to or greater than 65%.

6. The electrostatic charge image developer according to claim 1,
wherein a content of magnetic particle in the magnetic particle dispersed core particle is in a range of 45% by weight to 95% by weight.

7. The electrostatic charge image developer according to claim 1,
wherein the (meth)acrylic resin containing a nitrogen atom is formed from a monomer selected from dimethylaminoethyl (meth)acrylate and dimethylaminopropyl (meth)acrylate.

8. A developer cartridge which is detachable from an image forming apparatus, comprising:
a storing portion that stores the electrostatic charge image developer according to claim 1.

9. A process cartridge which is detachable from an image forming apparatus, the process cartridge comprising:
a developing unit that stores the electrostatic charge image developer according to claim 1 and develops an electrostatic charge image formed on a surface of an image holding member as a toner image using the electrostatic charge image developer.
